(19) United States
(12) Patent Application Publication
(10) Pub. No.: US 2003/0061099 A1
(43) Pub. Date: Mar. 27, 2003

(54) Point system, sales method using the system and program for the system

(75) Inventor: Motohisa Watanabe, Tokyo (JP)

Correspondence Address: SUGHRUE MION, PLLC, 2100 PENNSYLVANIA AVENUE, N.W., WASHINGTON, DC, 20037, US

(73) Assignee: NEC INFRONTIA CORPORATION

(21) Appl. No.: 10/253,929

(22) Filed: Sep. 25, 2002

(30) Foreign Application Priority Data
Sep. 26, 2001 (JP) 2001-294768

(51) Int. Cl. G06F 17/60

(52) U.S. Cl. 705/14; 705/16

(57) ABSTRACT

The invention provides a point system wherein point services can be used universally across different enterprises and a commodity can be purchased from an enterprise which does not provide a point service using a point number of a different enterprise. An A company retail shop terminal transmits a customer number of a customer, and a D company point management host computer reads in a point number of the customer. A point service host computer converts the point number into a point number of the A company with an A company point conversion rate, and the A company retail shop terminal calculates an amount of money available for purchase from the point number of the A company with an internal conversion rate and urges the customer to select use or accumulation of its points. If accumulation is selected, then the A company retail shop terminal converts the amount of money for the commodity into a point number of the A company with the internal conversion rate, and the point service host computer converts the point number of the A company into a point number of the D company with an A company point addition rate, and the D company point management host computer adds the point number of the D company to the accumulated point number of the customer. A result of the addition is converted into a point number of the A company with the A company point conversion rate, and the A company retail shop terminal displays the point number of the A company to notify the customer.

### BACKGROUND OF THE INVENTION

1. Field of the Invention

The present invention relates to a point system, a sales method which uses the point system and a program for the point system, and more particularly to a point system in which a plurality of sales enterprises or distributors participate, and a sales method which uses the point system and a program for the point system.

2. Description of the Related Art

Conventionally, a point service wherein points are provided in response to a purchase price is provided by various enterprises, and usually such enterprises individually determine an amount of money for a point to be serviced, a number of points, a method of realizing a service and so forth.

A point-of-sales (POS) terminal apparatus, which is directed to a similar technical field to that to which the present invention belongs, is disclosed in Japanese Patent Laid-Open No. 29073/1995 (hereinafter referred to as prior art 1). According to the apparatus of the prior art 1, a customer point master is provided in a POS terminal apparatus which manages point services in order to reduce the load applied to a host computer.

As a system directed to a similar technical field to that to which the invention belongs, a point tabulation system is disclosed in Japanese Patent Laid-Open No. 124754/1998 (hereinafter referred to as prior art 2). According to the point tabulation system of the prior art 2, the system is connected to a network such that terminals of participants function as terminals of the point tabulation system thereby to build up a point network system with comparatively small funds.

As another system directed to a similar technical field to that to which the invention belongs, a sales point integrated management system is disclosed in Japanese Patent Laid-Open No. 2001-43451 (hereinafter referred to as prior art 3). According to the sales point integrated management system, point data to be handled are classified into and managed as two different categories of deposited points and card points such that they can move between the two categories thereby to suppress the time and the cost required for communication processing in a transaction such as a commodity sales transaction.

However, according to the conventional point service, since the amount of money of a point to be serviced, the number of points, the realization method of the service and so forth are different among different enterprises, the point service cannot be used universally across the enterprises.

Further, the apparatus and systems of the prior art 1 to the prior art 3 described above are individually different in terms of the purpose and advantage from the invention of the present application. Further, even if the techniques of the prior art 1 to the prior art 3 are combined, the point service cannot be used universally across the enterprises because they are individually directed to augmentation in efficiency of the point service and do not provide a counter measure for conversion of the point service between the enterprises which have customer information different from each other.

### SUMMARY OF THE INVENTION

It is an object of the present invention to provide a point service product sales system (point system), a point service product sales method (sales method which uses the point system) and a program for the point system where in point services of different enterprises which are not used universally across the different enterprises can be used universally across the different enterprises.

It is another object of the present invention to provide a point service product sales system (point system), a point service product sales method (sales method which uses the point system) and a program for the point system wherein a purchase price by a point number accumulated in an enterprise can be paid to another enterprise which does not provide a point service and does not allow such payment.

In order to attain the objects described above, according to an aspect of the present invention, there is provided a point system, comprising one or more management enterprises for managing point services to purchase amounts of money of customers and a point management host computer provided in each of the management enterprises, a plurality of member enterprises which are members of the point system including the management enterprises and a sales terminal provided in each of the member enterprises, a point service host computer for integrating the point services, and a network for interconnecting the point management host computers, the sales terminals and the point service host computer, the point service host computer including point number conversion means for converting a point number of one of the management enterprises into a point number of another one of the management enterprises, receivable money amount storage means for storing values of a receivable amount of money upon settlement after a transfer of a point number is performed between different ones of the member enterprises, and payable money amount storage means for storing values of a payable amount of money upon the settlement after the transfer of a point number is performed between the different ones of the member enterprises, each of the sales terminals including point/money amount conversion means for converting a commodity purchase amount of money in one of the management enterprises into a point number of the management enterprise and for converting a point number of one of the management enterprises into an amount of money available for purchase from the management enterprise, whereby, when a customer inputs a customer number issued by one of the management enterprises and a personal identification number to the sales terminal of one of the member enterprises other than the issuing source enterprise from which the customer number has been issued, if the customer selects to store a point number based on the purchase amount of money for the commodity into the issuing source enterprise, the purchase amount of money for the commodity is converted into a point number of a selling source one of the member enterprises from which the commodity is to be purchased by the point/money amount conversion means and the point number obtained by the conversion by the point/money amount conversion means is converted into a point number of the issuing source enterprise by the point number conversion means, and the point number obtained by the point number conversion means is added to the point number stored in a coordinated relationship with the customer number of the customer and then the value of the purchase amount of money for the commodity is stored into the payable money amount storage means for the selling source enterprise and the receivable money amount storage means for the issuing source enterprise, but if the customer selects to use the point number stored in the issuing source enterprise to purchase the commodity, the purchase amount of money for the commodity is converted into a point number of the selling source enterprise by the point/money amount conversion means and the point number obtained by the conversion by the point/money amount conversion means is converted into a point number of the issuing source enterprise by the point conversion means, and the point number obtained by the conversion by the point conversion means is subtracted from the point number stored in a coordinated relationship with the customer number of the customer in the issuing source enterprise and then the value of the purchase amount of money for the commodity is stored into the receivable money amount storage means for the selling source enterprise and the payable money amount storage means for the issuing source enterprise.

The point service host computer may further include second point/money amount conversion means for converting a purchase amount of money in one of the member enterprises other than the management enterprises into a point number of one of the management enterprises and for converting a point number of one of the management enterprises into an amount of money available for purchase from one of the member enterprises other than the management enterprises, whereby, when a customer inputs a customer number issued by one of the management enterprises and a personal identification number to the sales terminal of one of the member enterprises other than the management enterprises to purchase a commodity, the purchase amount of money for the commodity is converted into a point number of the issuing source enterprise of the customer number of the customer by the second point/money amount conversion means and the point number obtained by the conversion by the second point/money amount conversion means is subtracted from the point number stored in a coordinated relationship with the customer number of the customer in the issuing source enterprise, and then the value of the purchase amount of money for the commodity is stored into the receivable money amount storage means for the selling source enterprise and the payable money amount storage means for the issuing source enterprise.

Each of the sales terminals may accept an input of the customer number and the personal identification number over the network from a terminal apparatus of the customer connected to the network.

The issuing source enterprise may issue the customer number of the customer and the personal identification number with a point card, and each of the sales terminals maybe installed in a retail shop and receive an input of the customer number and the personal identification number through the point card.

According to another aspect of the present invention, there is provided a sales method which uses a point system including one or more management enterprises for managing point services to purchase amounts of money of customers and a point management host computer provided in each of the management enterprises, a plurality of member enterprises which are members of the point system including the management enterprises and a sales terminal provided in each of the member enterprises, a point service host computer for integrating the point services, and a network for interconnecting the point management host computers, the sales terminals and the point service host computer, comprising an acceptance step executed by one of the sales terminals of accepting a customer number and a personal identification number from a customer, a transmission step executed by the sales terminal of transmitting the customer number and the personal identification number to the point management host computer of an issuing source one of the management enterprises from which the customer number has been issued, a reading-in step executed by the point management host computer of collating the customer number and the personal identification number received from the sales terminal with data stored in a storage section of the point management host computer to read in a point number coordinated with the customer number, a point conversion step executed by the point service host computer of converting the point number of the issuing source enterprise read in at the reading-in step into a point number of a selling source one of the member enterprises from which the commodity is to be purchased, a money amount conversion step of converting the point number obtained by the conversion at the point conversion step into an amount of money available for purchase with the sales terminal, a display step executed by the sales terminal of displaying the amount of money available for purchase obtained by the conversion at the money amount conversion step and a screen for allowing the customer to select whether or not the amount of money available for purchase is used to purchase the commodity with the sales terminal, an addition step of adding, when the customer selects to purchase the commodity without using the amount of money available for purchase on the screen for selection, a point number corresponding to the amount of money available for purchase of the commodity to the point number coordinated with the customer number and cumulatively storing the value of the purchase amount of money for the commodity into the payable money amount storage means for the selling source enterprise and the receivable money amount storage means for the issuing source enterprise, a subtraction step of subtracting, when the customer selects to use the amount of money available for purchase to purchase the commodity on the screen for selection, a point number corresponding to the purchase amount of money for the commodity from the point number coordinated with the customer number and cumulatively storing the value of the purchase amount of money for the commodity into the receivable money amount storage means for the selling source enterprise and the payable money amount storage means for the issuing source enterprise, and a payment step of paying, at a time determined in advance after the commodity is sold to the customer through the addition step or the subtraction step, the amount of money stored in the payable money amount storage means for the issuing source enterprise from the issuing source enterprise to the selling source enterprise and paying the amount of money stored in the payable money amount storage means for the selling source enterprise from the selling source enterprise to the issuing source enterprise.

According to a further aspect of the present invention, there is provided a sales method which uses a point system including one or more management enterprises for managing point services to purchase amounts of money of customers and a point management host computer provided in each of the management enterprises, a plurality of member enterprises which are members of the point system including the management enterprises and a sales terminal provided in each of the member enterprises, a point service host computer for integrating the point services, and a network for interconnecting the point management host computers, the sales terminals and the point service host computer, comprising an acceptance step executed by one of the sales terminals of accepting a customer number and a personal identification number from a customer, a transmission step executed by the sales terminal of transmitting the customer number and the personal identification number to the point management host computer of an issuing source one of the management enterprises from which the customer number has been issued, a reading-in step executed by the point management host computer of collating the customer number and the personal identification number received from the sales terminal with data stored in a storage section of the point management host computer to read in a point number coordinated with the customer number, a conversion step executed by the point service host computer of converting the point number of the issuing source enterprise read in at the reading-in step into an amount of money available for purchase with the sales terminal, a display step executed by the sales terminal of displaying the amount of money available for purchase and a screen for allowing the customer to select whether or not the amount of money available for purchase is used to purchase the commodity with the sales terminal, a sales step of selling the commodity with the cash when the customer selects to purchase the commodity without using the amount of money available for purchase on the screen for selection, a subtraction step of subtracting, when the customer selects to use the amount of money available for purchase to purchase the commodity on the screen for selection, a point number corresponding to the purchase amount of money for the commodity from the point number coordinated with the customer number and cumulatively storing the value of the purchase amount of money for the commodity into the receivable money amount storage means for the selling source enterprise and the payable money amount storage means for the issuing source enterprise, and a payment step of paying, after the commodity is sold to the customer through the subtraction step, the amount of money stored in the payable money amount storage means for the issuing source enterprise to the selling source enterprise.

In both of the sales methods, at the acceptance step, the customer number and the personal identification number may be accepted over the network from a terminal apparatus of the customer connected to the network, or alternatively, a point card issued by the issuing source enterprise may be read in by the sales terminal located in a retail shop to accept the customer number and the personal identification number.

According to a still further aspect of the present invention, there is provided a program for causing a point system, which includes one or more management enterprises for managing point services to purchase amounts of money of customers and a point management host computer provided in each of the management enterprises, a plurality of member enterprises which are members of the point system including the management enterprises and a sales terminal provided in each of the member enterprises, a point service host computer for integrating the point services, and a network for interconnecting the point management host computers, the sales terminals and the point service host computer, to execute an acceptance process by one of the sales terminals of accepting a customer number and a personal identification number from a customer, a transmission process by the sales terminal of transmitting the customer number and the personal identification number to the point management host computer of an issuing source one of the management enterprises from which the customer number has been issued, a reading-in process by the point management host computer of the issuing source enterprise of collating the customer number and the personal identification number received from the sales terminal with data stored in a storage section of the point management host computer to read in a point number coordinated with the customer number, a point conversion process by the point service host computer of converting the point number of the issuing source enterprise read in through the reading-in process into a point number of a selling source one of the member enterprises from which the commodity is to be purchased, a money amount conversion process by the sales terminal of converting the point number read in into an amount of money available for purchase with the sales terminal, a display process by the sales terminal of displaying the amount of money available for purchase obtained through the money amount conversion process and a screen for allowing the customer to select whether or not the amount of money available for purchase is used to purchase the commodity with the sales terminal, an addition process by the point management host computer of the issuing source enterprise of adding, when the customer selects to purchase the commodity without using the amount of money available for purchase on the screen for selection, a point number corresponding to the amount of money available for purchase of the commodity to the point number coordinated with the customer number, a process by the point service host computer of cumulatively storing the value of the purchase amount of money for the commodity into payable money amount storage means for the selling source enterprise and receivable money amount storage means for the issuing source enterprise, a subtraction process by the point management host computer of the issuing source enterprise of subtracting, when the customer selects to use the amount of money available for purchase to purchase the commodity on the screen for selection, a point number corresponding to the purchase amount of money for the commodity from the point number coordinated with the customer number, a process by the point service host computer of cumulatively storing the value of the purchase amount of money for the commodity into receivable money amount storage means for the selling source enterprise and payable money amount storage means for the issuing source enterprise, a process by the point management host computer of the issuing source enterprise of paying, at a time determined in advance after the commodity is sold to the customer through the addition process or the subtraction process, the amount of money stored in the payable money amount storage means for the issuing source enterprise to the selling source enterprise, and a process by the point management host computer of the selling source enterprise of paying the amount of money stored in the payable money amount storage means for the selling source enterprise to the issuing source enterprise.

According to a yet further aspect of the present invention, there is provided a program for causing a point system, which includes one or more management enterprises for managing point services to purchase amounts of money of customers and a point management host computer provided in each of the management enterprises, a plurality of member enterprises which are members of the point system including the management enterprises and a sales terminal provided in each of the member enterprises, a point service host computer for integrating the point services, and a network for interconnecting the point management host computers, the sales terminals and the point service host computer, to execute an acceptance process by one of the sales terminals of accepting a customer number and a personal identification number from a customer, a transmission process by the sales terminal of transmitting the customer number and the personal identification number to the point management host computer of an issuing source one of the management enterprises from which the customer number has been issued, a reading-in process by the point management host computer of the issuing source enterprise of collating the customer number and the personal identification number received from the sales terminal with data stored in a storage section of the point management host computer to read in a point number coordinated with the customer number, a conversion process by the point service host computer of converting the point number of the issuing source enterprise read in at the reading-in process into an amount of money available for purchase with the sales terminal, a display process by the point service host computer of displaying the amount of money available for purchase and a screen for allowing the customer to select whether or not the amount of money available for purchase is used to purchase the commodity with the sales terminal, a subtraction process by the point management host computer of the issuing source enterprise of subtracting, when the customer selects to use the amount of money available for purchase to purchase the commodity on the screen for selection, a point number corresponding to the purchase amount of money for the commodity from the point number coordinated with the customer number, a storage process by the point service host computer of cumulatively storing the value of the purchase amount of money for the commodity into receivable money amount storage means for the selling source enterprise and payable money amount storage means for the issuing source enterprise, and a process by the point management host computer of the issuing source enterprise of paying, after the storage process is completed, the amount of money stored in the payable money amount storage means for the issuing source enterprise to the selling source enterprise.

In both of the programs, in the acceptance process, the customer number and the personal identification number may be accepted over the network from a terminal apparatus of the customer connected to the network, or alternatively, a point card issued by the issuing source enterprise may be read in by the sales terminal located in a retail shop to accept the customer number and the personal identification number.

With the point system, the sales methods and the programs, point numbers or a purchase amount of money and a point number can be exchanged or transferred between the enterprises which participate in the point system, and settlement after such transfer of point services is performed can be performed between the enterprises. Consequently, a customer can use point services of different enterprises universally across the enterprises to accumulate a point number and can use the point number accumulated in this manner for the payment to a different company. Particularly as the number of enterprises which participate in the point system increases, the convenience to the customers increases progressively. Further, it is beneficial to an enterprise (management enterprise) which provides a point service that the enterprise can expand the point service of itself also to those customers who make use of point services of the other companies without particularly issuing a point card or the like of the enterprise itself. Meanwhile, it is beneficial to a participant enterprise which does not provide a point service that the enterprise can provide a further service to those customers who have point cards or the like of the other companies without the necessity for the labor or the expense to issue point cards of the enterprise itself. Furthermore, point numbers by point services by a plurality of enterprises can be utilized as integrated services without changing the addition rate or the subtraction rate of the point number between the enterprises every time.

Further, with the point system, the sales methods and the programs, purchase can be accepted not only from a retail shop terminal of a participant enterprise of the point system but also from a server (sales center terminal) which sells over a network. Consequently, such accumulation of a point number or payment by a point number through universal use of point services as described above can be achieved not only for those customers who come to a shop but also for those customers who make use of the network sales from a terminal apparatus (user terminal).

The above and other objects, features and advantages of the present invention will become apparent from the following description and the appended claims, taken in conjunction with the accompanying drawings in which like parts or elements are denoted by like reference symbols.

### BRIEF DESCRIPTION OF THE DRAWINGS

FIG. 1 is a block diagram showing an example of a basic configuration of a point system to which the present invention is applied;

FIG. 2 is a block diagram illustrating data stored in components of the point system of FIG. 1;

FIG. 3 is a flow diagram illustrating a point addition process when a customer buys a commodity in a retail shop of an A company using an A company point card;

FIG. 4 is a flow diagram illustrating a point process when a customer buys a commodity in a retail shop of the company with a point number using the A company point card;

FIG. 5 is a flow diagram illustrating a point process when a customer buys a commodity of the A company using a D company point card, whereupon points are added;

FIG. 6 is a flow diagram illustrating a point process when a customer buys a commodity of the A company with a point number of the D company using the D company point card;

FIG. 7 is a flow diagram illustrating a point process of payment and reception of a service price after point numbers are settled between the A company and the D company;

FIG. 8 is a block diagram showing an example of a basic configuration of another point system to which the present invention is applied;

FIG. 9 is a block diagram schematically illustrating data stored in components of the point system of FIG. 8 except a point service host computer;

FIG. 10 is a block diagram schematically illustrating data stored in the point service host computer of the point system of FIG. 8;

FIG. 11 is a flow diagram illustrating a point process when a customer buys a commodity of an A company over a network using an A company point card, whereupon points are added;

FIG. 12 is a flow diagram illustrating a point process when a customer buys a commodity of the A company with a point number over the network using the A company point card;

FIGS. 13 and 14 are flow diagrams illustrating a point process when a customer buys a commodity of the A company over the network with a customer number of the D company, whereupon points are accumulated;

FIGS. 15 and 16 are flow diagrams illustrating a point process when a customer buys a commodity of the A company over the network with a customer number of the D company using points;

FIG. 17 is a flow diagram illustrating a point process in payment and reception of a service price after point numbers are settled between the A company and the D company;

FIGS. 18 and 19 are flow diagrams illustrating a process when a customer buys a commodity of a G company from a retail shop terminal of the G company with the customer number of the D company using points of the D company; and

FIGS. 20 and 21 are flow diagrams illustrating a process when a customer buys a commodity of an F company from the F company over a network using points of the D company with a customer number of the D company.

### DESCRIPTION OF THE PREFERRED EMBODIMENTS

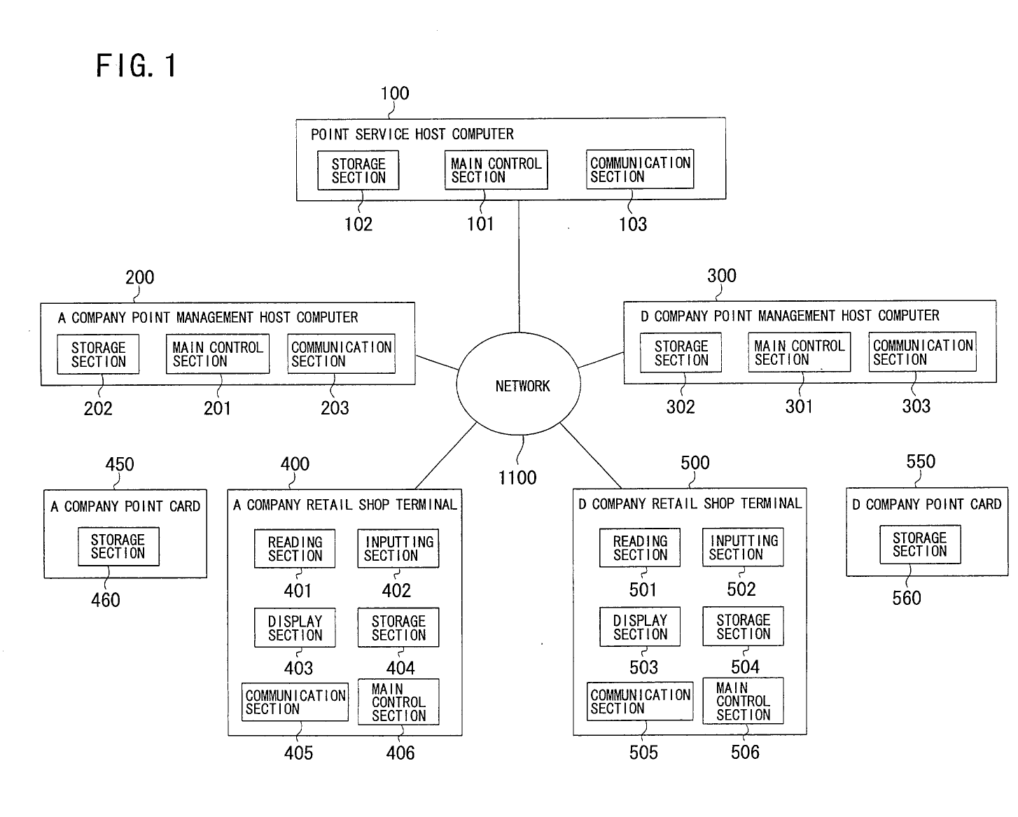

Referring first to FIG. 1, there is shown an example of a basic configuration of a point system to which the present invention is applied. The point system shown includes a point service host computer 100, an A company point management host computer 200 of an A company which provides a point card service, a D company point management host computer 300 of a D company which provides another point card service similarly to the A company, an A company retail shop terminal 400, and a D company retail shop terminal 500 all connected to a network 1100. A customer who enjoys the point card service of the A company possesses an A company point card 450 while another customer who enjoys the point card service of the D company possesses a D company point card 550.

Each of the A company and the D company is an enterprise (management enterprise) which issues customer numbers to provide a point service and owns a point management host computer to manage the point service of the A company or the D company itself, and therefore is an enterprise (member enterprise) which is a member of or a participant in the point system of the present embodiment.

The components of the point system are individually described below.

The point service host computer 100 includes a main control section 101, a storage section 102 and a communication section 103.

The A company point management host computer 200 includes a main control section 201, a storage section 202 and a communication section 203.

The D company point management host computer 300 includes a main control section 301, a storage section 302 and a communication section 303.

The main control sections 101, 201 and 301 include each a CPU for controlling the entire computer and so forth. The storage sections 102, 202 and 302 store various data and programs. The communication sections 103, 203 and 303 communicate with another information apparatus over the network 1100.

Since the computers mentioned above may be formed from a known hardware configuration, detailed description thereof is omitted herein.

The A company retail shop terminal 400 includes a reading section 401, an inputting section 402, a display section 403, a storage section 404, a communication section 405 and a main control section 406.

The D company retail shop terminal 500 includes a reading section 501, an inputting section 502, a display section 503, a storage section 504, a communication section 505 and a main control section 506.

Each of the reading sections 401 and 501 accepts a point card of a member enterprise which is a member of the point system according to the present invention and reads information stored in the point card. The inputting sections 402 and 502 are each used by a customer to input required information such as a personal identification number, and each of the display sections 403 and 503 displays a point number at present of the customer and so forth. The storage sections 404 and 504 store various data and programs. The communication sections 405 and 505 communicate with another information apparatus over the network 1100. Each of the main control sections 406 and 506 controls the entire retail shop terminal.

It is to be noted that, where each of the reading sections 401 and 501 cannot read all point cards of the member enterprises using a single reading section, if necessary, it maybe configured additionally including a reading section for exclusive use for reading a point card of an enterprise which cannot be read by the single reading section.

Since the retail shop terminals described above may have a known hardware configuration, detailed description thereof is omitted herein.

The A company point card 450 includes a storage section 460. The storage section 460 may be a storage medium such as a magnetic tape for storing information.

The D company point card 550 includes a storage section 560. The storage section 560 may be a storage medium such as a magnetic take for storing information.

The point service host computer 100, A company point management host computer 200, D company point management host computer 300, A company retail shop terminal 400 and D company retail shop terminal 500 described above are connected to the network 1100 so that they can communicate data with each other over the network 1100. The network 1100 may be any network if it is a computer network for interconnecting information apparatus, and may be, for example, the Internet or a LAN.

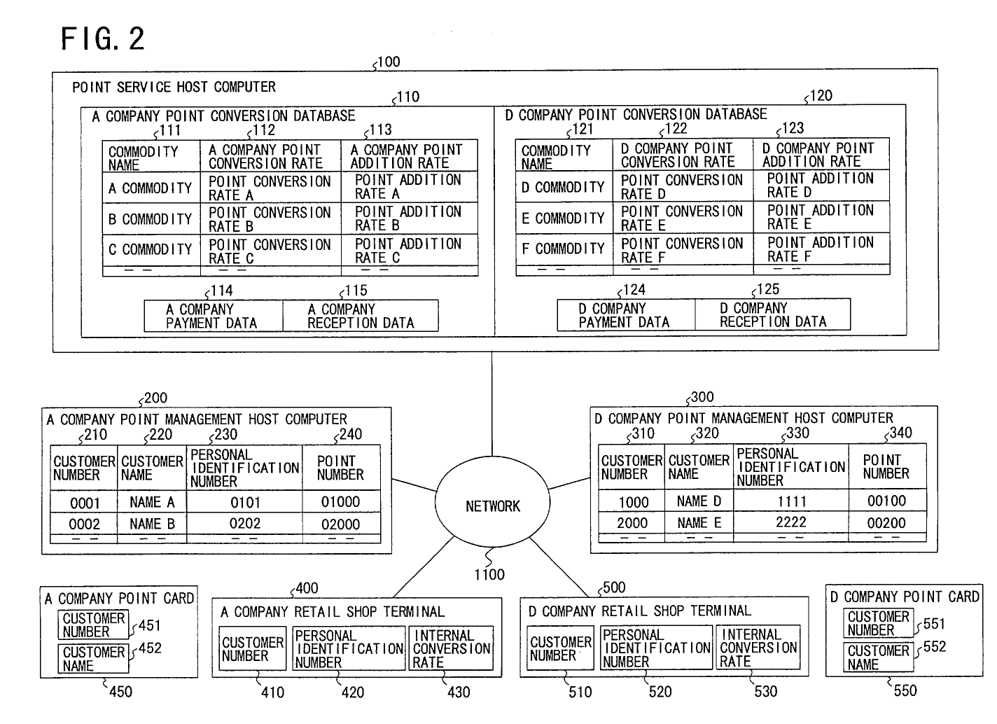

FIG. 2 illustrates data stored in the components of the point system of FIG. 1. The components and the data stored in the components are described below with reference to FIG. 2.

The point service host computer 100 integrates the services of the companies which provide point card services and includes an A company point conversion database 110 for storing information of the point cards of the A company and a D company point conversion database 120 for storing information of the point cards of the D company.

The A company point conversion database 110 stores commodity names 111, A company point conversion rates 112, A company point addition rates 113, A company payment data 114 and A company reception data 115.

Each of the A company point conversion rates 112 indicates a conversion rate to be used for conversion of a point number of the D company into a point number of the A company when a customer purchases a commodity of the A company with a point number of a point card of the D company. In particular, each A company point conversion rate 112 indicates a point conversion rate between the A company and the D company upon point conversion other than point conversion in the case wherein, when a customer purchases a commodity of the A company indicating a customer number 551 issued by the D company, a point number based on the amount of money required for the purchase is cumulatively added to a point number accumulated already. Such A company point conversion rates 112 are stored in a coordinated relationship with the commodity names 111 of the A company in respective storage areas of the storage section 102. The values of the A company point conversion rates 112 are decided in an agreement between the A company and the D company in advance in order to allow point cards to be utilized between the A company and the D company.

Each of the A company point addition rates 113 indicates an addition rate to be used for conversion of a point number to be added in the D company into a point number to be added in the A company when a customer purchases a commodity of the A company with a point card of the D company. In particular, each A company point addition rate 113 indicates a conversion rate between the A company and the D company in the case wherein a point number according to the amount of money required for the purchase is cumulatively added to a point number accumulated already when a customer purchases a commodity of the A company indicating the customer number 551 issued by the D company. Such A company point addition rates 113 are stored in a coordinated relationship with the commodity names 111 of the A company in respective storage areas of the storage section 102. The values of the A company point addition rates 113 are decided in an agreement between the A company and the D company in advance similarly to the values of the A company point conversion rate 112.

The A company payment data 114 indicates an amount of money to be paid by the A company upon settlement after point services when such point services are performed by the A company and the D company with points converted into points of the opposite companies. In particular, upon settlement after points are transferred between the enterprises, the value of an amount of money to be paid by the A company is accumulated into the A company payment data 114. In other words, the point service host computer 100 functions as payable money amount storage means. The time for such settlement is decided in advance.

The A company reception data 115 indicates an amount of money to be received by the A company upon settlement after point services when such point services are performed by the A company and the D company with points converted into points of the opposite companies. In particular,upon settlement after points are transferred between the enterprises, the value of an amount of money to be received by the A company is stored into the A company reception data 115. In other words, the point service host computer 100 functions as receivable money amount storage means. The time for such settlement is decided in advance.

The D company point conversion database 120 stores commodity name 121, D company point conversion rate 122, D company point addition rate 123, D company payment data 124 and D company reception data 125.

Each of the D company point conversion rates 122 indicates a conversion rate to be used for conversion of a point number of the A company into a point number of the D company when a customer purchases a commodity of the D company with a point number of a point card of the A company. In particular, each D company point conversion rate 122 indicates a point conversion rate between the A company and the D company upon point conversion other than point conversion in the case wherein, when a customer purchases a commodity of the D company indicating a customer number 451 issued by the A company, a point number based on the amount of money required for the purchase is cumulatively added to a point number accumulated already. Such D company point conversion rates 122 are stored in a coordinated relationship with the commodity names 121 of the D company in respective storage areas of the storage section 102. The values of the D company point conversion rates 122 are decided in an agreement between the A company and the D company in advance in order to allow point cards to be utilized between the A company and the D company.

Each of the D company point addition rates 123 indicates an addition rate to be used for conversion of a point number to be added in the A company into a point number to be added in the D company when a customer purchases a commodity of the D company with a point card of the A company. In particular, each D company point addition rate 123 indicates a conversion rate between the A company and the D company in the case wherein a point number according to the amount of money required for the purchase is cumulatively added to a point number accumulated already when a customer purchases a commodity of the D company indicating the customer number 451 issued by the A company. Such D company point addition rates 123 are stored in a coordinated relationship with the commodity names 121 of the D company in respective storage areas of the storage section 102. The values of the D company point addition rates 123 are decided in an agreement between the A company and the D company in advance similarly to the values of the D company point conversion rate 122.

The D company payment data 124 indicates an amount of money to be paid by the D company upon settlement after point services when such point services are performed by the A company and the D company with points converted into points of the opposite companies. In particular, upon settlement after points are transferred between the enterprises, the value of an amount of money to be paid by the D company is stored into the D company payment data 124. In other words, the point service host computer 100 functions as payable money amount storage means. The time for such settlement is decided in advance.

The D company reception data 125 indicates an amount of money to be received by the D company upon settlement after point services when such point services are performed by the A company and the D company with points converted into points of the opposite companies. In particular, upon settlement after points are transferred between the enterprises, the value of an amount of money to be received by the A company is stored into the D company reception data 125. In other words, the point service host computer 100 functions as receivable money amount storage means. The time for such settlement is decided in advance.

The A company point management host computer 200 stores customer numbers 210, customer names 220, personal identification numbers 230 and point numbers 240 as customer data for a service of the point cards by the A company in a coordinated relationship with the data of the customer numbers 210 in respective areas of the storage section 202.

The D company point management host computer 300 stores customer numbers 310, customer names 320, personal identification numbers 330 and point numbers 340 as customer data for a service of the point cards by the D company in a coordinated relationship with the data of the customer number 310 in respective areas of the storage section 302.

The storage section 404 of the A company retail shop terminal 400 includes a customer number 410 for storing a customer number read by the reading section 401 from a point card of an enterprise which participate in the point system, a personal identification number 420 for storing a personal identification number inputted from the inputting section 402, and an internal conversion rate 430 for storing an internal conversion rate to be used for conversion between a point number and an amount of money in the A company. The internal conversion rate (point/money amount conversion rate) 430 particularly is a conversion rate with which, when a customer purchases a commodity of the A company, the amount of money for the purchase is converted into a point number and, when a customer uses a point number to purchase a commodity of the A company, the point number of the A company is converted into an amount of money available for purchase from the A company.

Also the storage section 504 of the D company retail shop terminal 500 includes a customer number 510 for storing a customer number read by the reading section 501 from a point card of an enterprise which participate in the point system, a personal identification number 520 for storing a personal identification number inputted from the inputting section 502, and an internal conversion rate 530 for storing an internal conversion rate to be used for conversion between a point number and an amount of money in the D company. The internal conversion rate (point/money amount conversion rate) 530 particularly is a conversion rate with which, when a customer purchases a commodity of the D company, the amount of money for the purchase is converted into a point number and, when a customer uses a point number to purchase a commodity of the D company, the point number of the D company is converted into an amount of money available for purchase from the D company.

The A company point card 450 stores a customer number 451 and a customer name 452 as information for specifying a customer who possesses the A company point card 450 in predetermined areas of the storage section 460. Also the D company point card 550 stores a customer number 551 and a customer name 552 in predetermined areas of the storage section 560.

As described above, in the example of the configuration of the point system according to the first embodiment, a customer number, a customer name, a personal identification number and a point number of a customer who possesses an A company point card 450 (that is, to whom the customer number has been issued from the A company) are stored only in the A company point management host computer 200. Similarly, a customer number, a customer name, a personal identification number and a point number of a customer who possesses a D company point card 550 (that is, to whom the customer number has been issued from the D company) are stored only in the D company point management host computer 300. In other words, customer information of each management enterprise is stored only in the point management host computer of the management enterprise.

Since the point system according to the first embodiment is configured in such a manner as described above, the point service host computer 100 functions as first conversion means in the A company by converting a point number of a particular customer from among the point numbers 340 of the D company point management host computer 300 with the pertaining A company point addition rate 113.

Further, the point service host computer 100 functions as first conversion means in the D company by converting a point number of a particular customer from among the point numbers 240 of the A company point management host computer 200 with the pertaining D company point addition rate 123.

Further, the point service host computer 100 functions as second conversion means in the A company by converting a point number of a particular customer from among the point numbers 340 of the D company point management host computer 300 with the pertaining A company point conversion rate 112.

Furthermore, the point service host computer 100 functions as second conversion means in the D company by converting a point number of a particular customer from among the point numbers 240 of the A company point management host computer 200 with the pertaining D company point conversion rate 122.

Now, operation of the point system according to the first embodiment is described.

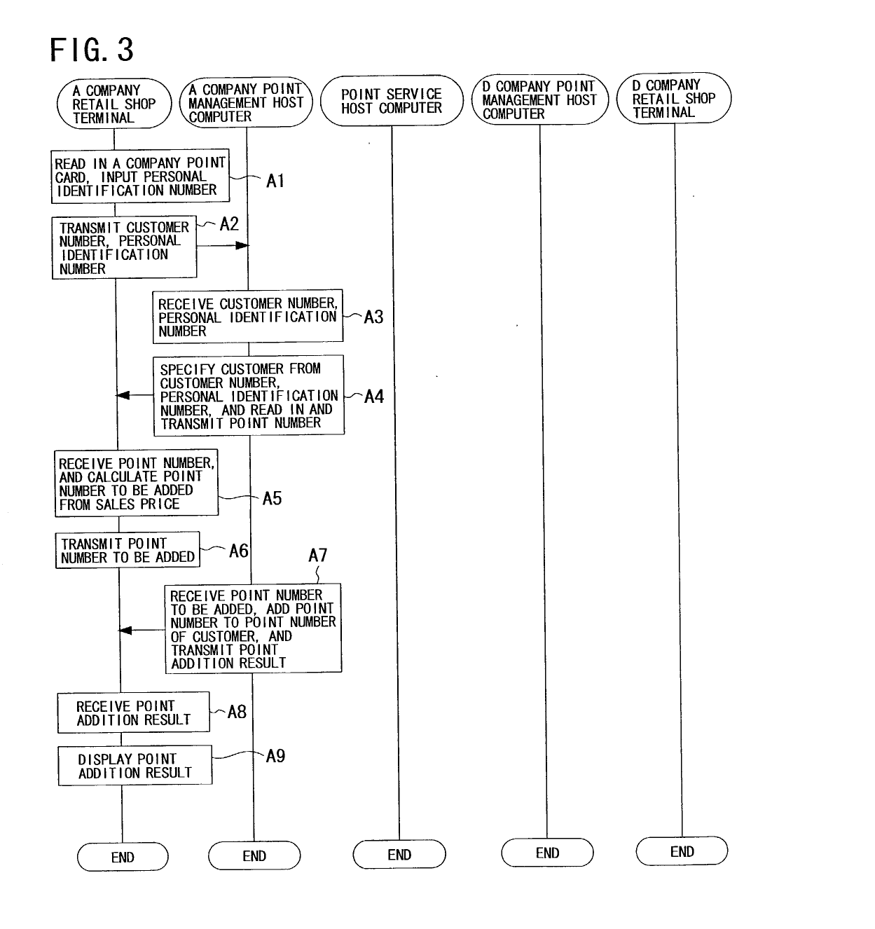

FIG. 3 illustrates a flow of a point addition process in the A company when a certain customer (hereinafter referred to as customer 1) purchases a commodity from a retail shop of the A company using its A company point card 450. When the customer 1 indicates the A company point card 450 to purchase a commodity in a retail ship of the A company from which the A company point card 450 has been issued, points originating from the purchased commodity are additionally accumulated into the A company point card 450 in a similar manner as in conventional point addition. Thus, operation of the point system of the first embodiment when the point process is performed is described with reference to FIG. 3.

The customer 1 who intends to purchase a commodity in a retail shop of the A company indicates the A company point card 450 when it wants to purchase a commodity. The A company retail shop terminal 400 reads data of the customer number 451 and the customer name 452 from the A company point card 450 indicated by the customer 1 by means of the reading section 401 and receives an input of a personal identification number from the customer 1 by means of the inputting section 402 (step A1). Then, in order to inquire about the customer and confirm the point number of the point card possessed by the customer 1, the A company retail shop terminal 400 transmits the customer number 410 and the inputted personal identification number 420 to the A company point management host computer 200 (step A2).

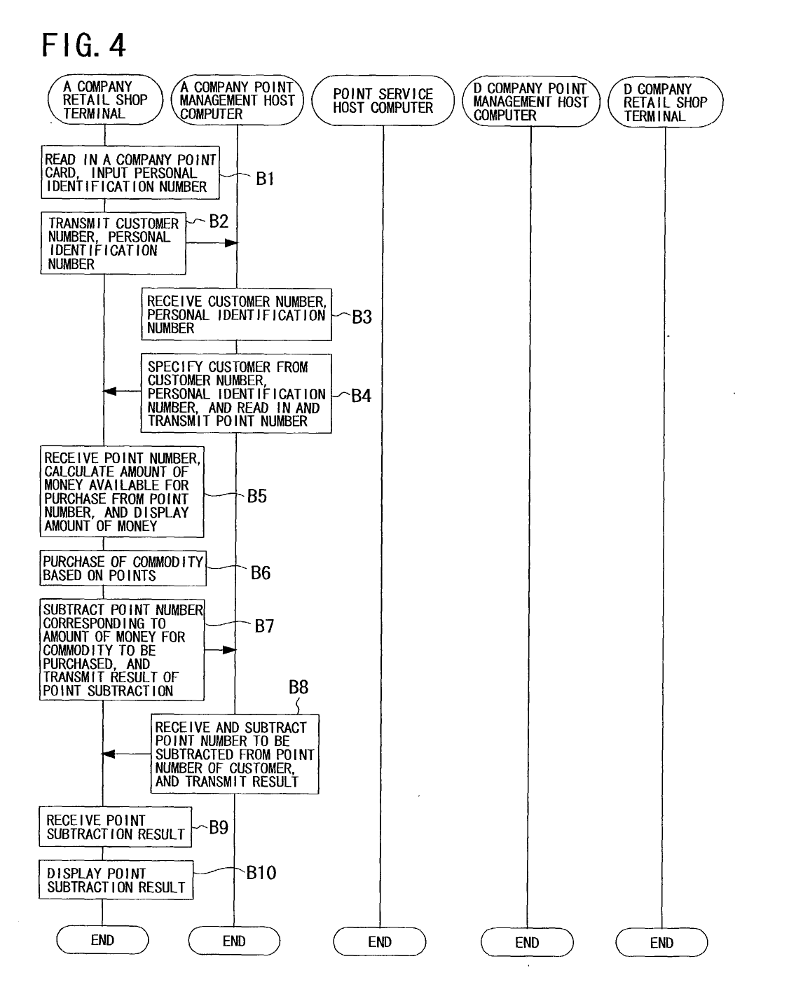

The A company point management host computer 200 receives the customer number 410 and the personal identification number 420 transmitted thereto from the A company retail shop terminal 400 (step A3) and refers to the customer number 210 and the personal identification number 230, and then transmits data of the point number 240 corresponding to the specified customer data to the A company retail shop terminal 400 (step A4). The A company retail shop terminal 400 receives the point number of the customer 1 and calculates an amount of money available for purchase from the point number with the internal conversion rate 430. Then, the A company retail shop terminal 400 displays the calculated amount of money available for purchase on the display section 403, and confirms whether the customer 1 selects, as a method of payment of the price of the commodity to be purchased, a method wherein the point number 240 is used for the payment or another method wherein the cash or the like is used for the payment of the price of the commodity and a point number provided by the purchase of the commodity is cumulatively added to the point number 240. In FIG. 3, it is illustrated that the customer 1 selects the method wherein a point number provided by the purchase of the commodity is cumulatively added to the point number 240. It is to be noted that the payment wherein a point number accumulated in the point number 240 is used for the payment is hereinafter described with reference to FIG. 4.

Where the method wherein the point number is added to the point number 240 is selected, the A company retail shop terminal 400 calculates a point number to be added with the internal conversion rate 430 from the sales price (purchase price) of the commodity (step A5) and transmits the calculated point number to the A company point management host computer 200 (step A6). After the A company point management host computer 200 receives the calculated point number to be added, it adds the received point number to the point number 240 of the customer data specified for the customer 1 and transmits a result of the addition to the A company retail shop terminal 400 (step A7). After the A company retail shop terminal 400 receives the result of the addition from the A company point management host computer 200 (step A8), it displays the received result on the display section 403 to indicate the point addition result to the customer 1 (step A9).

FIG. 4 illustrates a flow of a point process when the customer 1 purchases a commodity in a retail shop of the A company using the A company point card 450 thereof and pays the price of the commodity using a point number accumulated till then. It is a similar practice as in a conventional point process that the customer 1 indicates the A company point card 450 to purchase a commodity in a retail ship of the A company from which the A company point card 450 has been issued and a point number of the point card 450 is used to pay the price of the commodity. Thus, operation of the point system of the first embodiment when the point process is performed is described with reference to FIG. 3.

The customer 1 who intends to purchase a commodity in a retail shop of the A company indicates the A company point card 450 when it wants to purchase a commodity. The A company retail shop terminal 400 reads data of the customer number 451 and the customer name 452 from the A company point card 450 indicated by the customer 1 by means of the reading section 401 and receives an input of a personal identification number from the customer 1 by means of the inputting section 402 (step AB). Then, in order to inquire about the customer and confirm the point number of the point card possessed by the customer 1, the A company retail shop terminal 400 transmits the customer number 410 and the inputted personal identification number 420 to the A company point management host computer 200 (step A2).

The A company point management host computer 200 receives the customer number 410 and the personal identification number 420 transmitted thereto from the A company retail shop terminal 400 (step B3) and refers to the customer number 210 and the personal identification number 230, and then transmits data of the point number 240 corresponding to the specified customer data to the A company retail shop terminal 400 (step B4). The A company retail shop terminal 400 receives the point number of the customer 1 and calculates an amount of money available for purchase from the point number with the internal conversion rate 430. Then, the A company retail shop terminal 400 displays the calculated amount of money available for purchase on the display section 403, and confirms whether the customer 1 selects, as a method of payment of the price of the commodity to be purchased, a method wherein the point number accumulated in the point number 240 is used for the payment or another method wherein the cash or the like is used for the payment of the price of the commodity and a point number provided by the purchase of the commodity is cumulatively added to the point number 240 (step B5). In FIG. 4, it is illustrated that the customer 1 selects the method wherein the point number accumulated through purchases of commodities till then is used for the payment. It is to be noted that the operation of the point system when the method wherein the point number provided upon the purchase of the commodity is added to the point number 240 is described hereinabove with reference to FIG. 3.

If the customer 1 selects the method wherein the point number accumulated in the point number 240 is used for the payment (step B6), then the A company retail shop terminal 400 calculates a point number to be subtracted from the amount of money of the commodity of the commodity to be purchased with the internal conversion rate 430 and transmits the calculated point number to the A company point management host computer 200 (step B7). The A company point management host computer 200 receives the calculated point number to be subtracted and subtracts the point number from the point number 240 of the customer 1, and transmits a result of the subtraction to the A company retail shop terminal 400 (step B8). The A company retail shop terminal 400 receives the subtraction result transmitted thereto (step B9) and displays the received subtraction result on the display section 403 to indicate the point number at present as a result of the subtraction to the customer 1 (step B10).

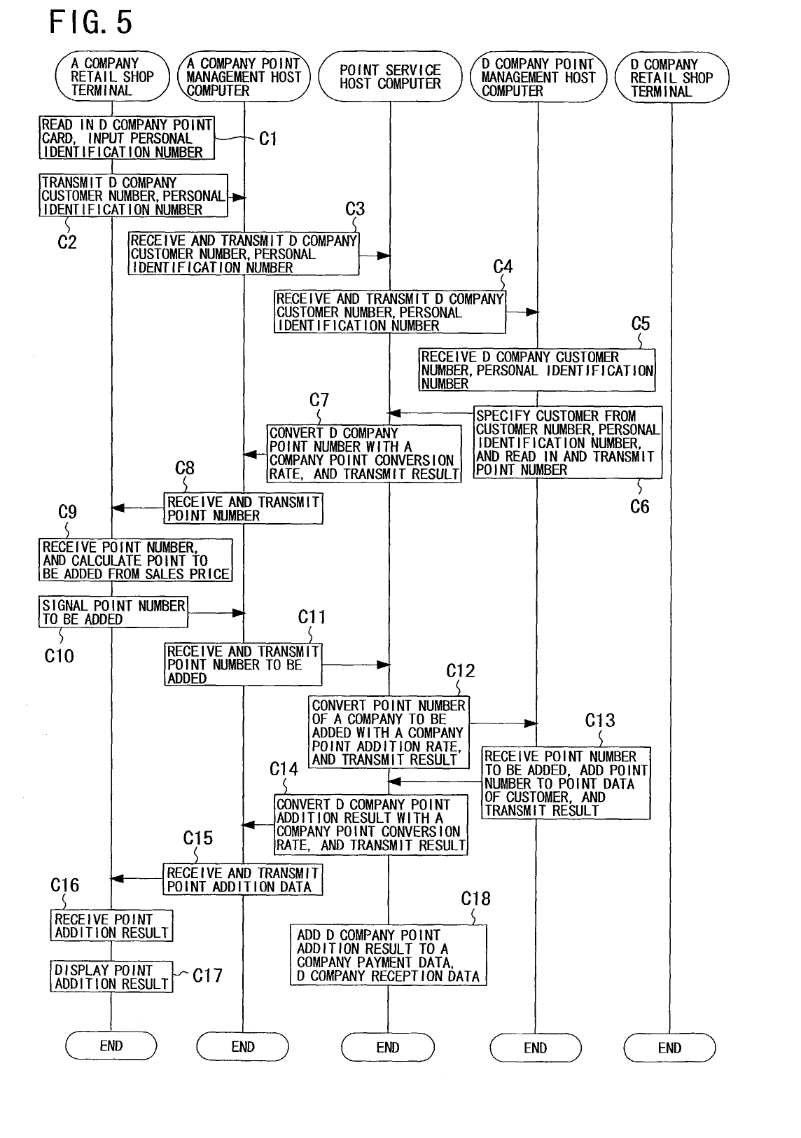

Now, a point addition process when a customer purchases a commodity of the A company using a point card of a company different from the A company which provides a point service in the point system of the first embodiment is described with reference to FIG. 5. In particular, the point addition process is performed when a customer purchases a commodity from one of management enterprises other than the enterprise from which a customer number has bee issued to the customer and points are accumulated in the issuing source enterprise. FIG. 5 illustrates a flow of a point addition process when the customer 1 purchases a commodity of the A company indicating its D company point card 550 and points provided based on the purchase amount of money for the commodity are added to the point number accumulated already.

It is assumed that, when the point addition process illustrated in FIG. 5 is performed, the customer 1 possesses a D company point card 550 and the D company point management host computer 300 has data of the customer number 310, customer name 320, personal identification number 330 and point number 340 with regard to the customer 1 stored in the respective areas of the storage section 302 thereof.

Also it is assumed that the pertaining A company point conversion rate 112 is already stored as a conversion rate to be used for conversion of a point number of the D company into a point number of the A company when a commodity of the A company is purchased with a point number of the point card of the D company in a predetermined area of the storage section 102 based on an agreement concluded in advance between the A company and the D company.

Further, it is assumed that the A company point addition rate 113 is already stored as an addition rate to be used for conversion of a point number to be added by the D company into a point number to be added by the A company when a commodity of the D company is purchased with the point card of the A company in a predetermined area of the storage section 102 based on an agreement concluded in advance between the A company and the D company.

It is to be noted that different conversion tables coordinated with the commodity names 111 may be prepared such that the A company point conversion rates 112 and the A company point addition rates 113 have different values among different commodities or commodity groups to be purchased. In other words, the A company point conversion rate 112 and the A company point addition rate 113 may be stored for each commodity or commodity group to be purchased in a predetermined area of the storage section 102.

Also it is assumed that the pertaining D company point conversion rate 122 is already stored as a conversion rate to be used for conversion of a point number of the A company into a point number of the D company when a commodity of the D company is purchased with a point number of the point card of the A company in a predetermined area of the storage section 102 based on an agreement concluded in advance between the D company and the D company.

Further, it is assumed that the D company point addition rate 123 is already stored as an addition rate to be used for conversion of a point number to be added by the A company into a point number to be added by the D company when a commodity of the A company is purchased with the point card of the D company in a predetermined area of the storage section 102 based on an agreement concluded in advance between the D company and the D company.

It is to be noted that different conversion tables coordinated with the commodity names 121 may be prepared such that the D company point conversion rates 122 and the D company point addition rates 123 have different values among different commodities or commodity groups to be purchased. In other words, the D company point conversion rate 122 and the D company point addition rate 123 may be stored for each commodity or commodity group to be purchased in a predetermined area of the storage section 102.

It is to be noted that, in the following description, if the commodity purchased by the customer 1 is a commodity of the A company, then a point conversion rate A is used for the A company point conversion rate 112 and a point addition rate A is used for the A company point addition rate 113. In other words, values of the A company point conversion rate 112 and the A company point addition rate 113 coordinated with the commodity of the A commodity are used.

When the customer 1 purchases a commodity in a retail shop of the A company, it indicates its D company point card 550 The A company retail shop terminal 400 reads the customer number 551 and the customer name 552 from the D company point card 550 by means of the reading section 401 and receives an input of a personal identification number of the customer 1 through the inputting section 402 (step C1). Then, in order to inquire about the customer 1 and confirm the point number accumulated in the D company point card 550 possessed by the customer 1, the A company retail shop terminal 400 transmits the read customer number 551 and the inputted personal identification number to the A company point management host computer 200 (step C2). The A company point management host computer 200 discriminates from the customer number 551 and the personal identification number received from the A company retail shop terminal 400 that the card of the customer 1 is not an A company point card 450 and transmits the received customer number 551 and personal identification number to the point service host computer 100 (step C3).

The point service host computer 100 transmits the customer number 551 and the personal identification number received from the A company point management host computer 200 to the D company point management host computer 300 in order to inquire about the customer number 551 and the personal identification number (step C4). The D company point management host computer 300 receives the customer number 551 and the personal identification number (step C5), and refers to the customer numbers 310 and the personal identification numbers 330 to specify data of the customer 1 and reads in the point number of the customer 1 in the D company from the pertaining point number 340 and then transmits the point number to the point service host computer 100 (step C6). The point service host computer 100 converts the point number of the customer 1 in the D company received from the D company point management host computer 300 into a point number of the A company with the A company point conversion rate 112 and transmits the point number of the A company to the customer name 220 (step C7).

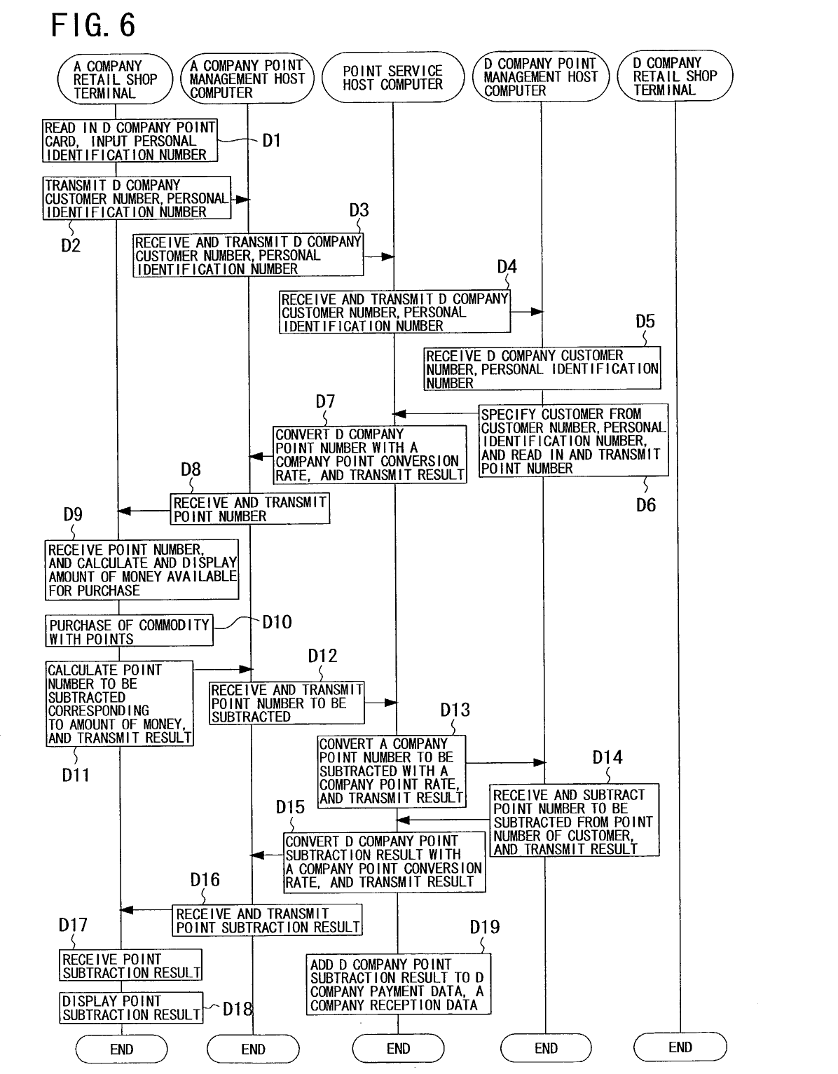

The A company point management host computer 200 transmits the point number after the conversion received from the point service host computer 100 to the A company retail shop terminal 400 (step C8). After the A company retail shop terminal 400 receives the point number of the customer 1 after the conversion, it calculates an amount of money available for purchase by means of the internal conversion rate 430 and displays the amount of money available for purchase on the display section 403. Then, the A company retail shop terminal 400 confirms whether the customer 1 selects, as a method of payment of the price of the commodity to be purchased, a method wherein the point number stored in the point number 340 is used for the payment or another method wherein the cash or the like is used for the payment of the price of the commodity and a point number provided by the purchase of the commodity is cumulatively added to the point number 340 of the D company. In FIG. 5, it is illustrated that the customer 1 selects the method wherein a point number provided by the purchase of the commodity is cumulatively added to the point number 340 of the D company. It is to be noted that the payment wherein the point number accumulated in the point number 340 is used for the payment is hereinafter described with reference to FIG. 6.

If the method wherein points are added to the point number 340 is selected, then the A company retail shop terminal 400 calculates a point number to be added in the A company from the price of the commodity (purchase amount of money) with the internal conversion rate 430 (step C9). Then, the A company retail shop terminal 400 transmits the calculated point number to the A company point management host computer 200 (step C10). Since the received point number to be added is a point number to be added to the point number 340 for the customer 1 who possesses a card of the D company, the A company point management host computer 200 transmits the received point number to be added to the point service host computer 100 (step C11). Since the received point number to be added is a point number of the A company, the point service host computer 100 converts the received point number to be added into a point number to be added in the D company using the A company point addition rate 113 and transmits the resulting point addition number to the D company point management host computer 300 (step C12).

The D company point management host computer 300 adds the point number to be added in the D company received from the point service host computer 100 to the data specified as data of the customer 1 in the point numbers 340 and transmits resulting data to the point service host computer 100 (step C13).

The point service host computer 100 converts, in order to allow the customer 1 to confirm the result of the point addition performed, the received point addition result into a point number of the A company with the A company point conversion rate 112 and transmits the resulting point number to the A company point management host computer 200 (step C14). The A company point management host computer 200 transmits the received point number to the A company retail shop terminal 400 (step C15). After the point addition result in the form of a point number of the A company is received (step C16), the A company retail shop terminal 400 displays the received point addition result as a result of addition of a point number to the point number 340 of the D company when the customer 1 purchases the commodity of the A company indicating the D company point card 550 so that the customer 1 may confirm the point addition result (step C17).

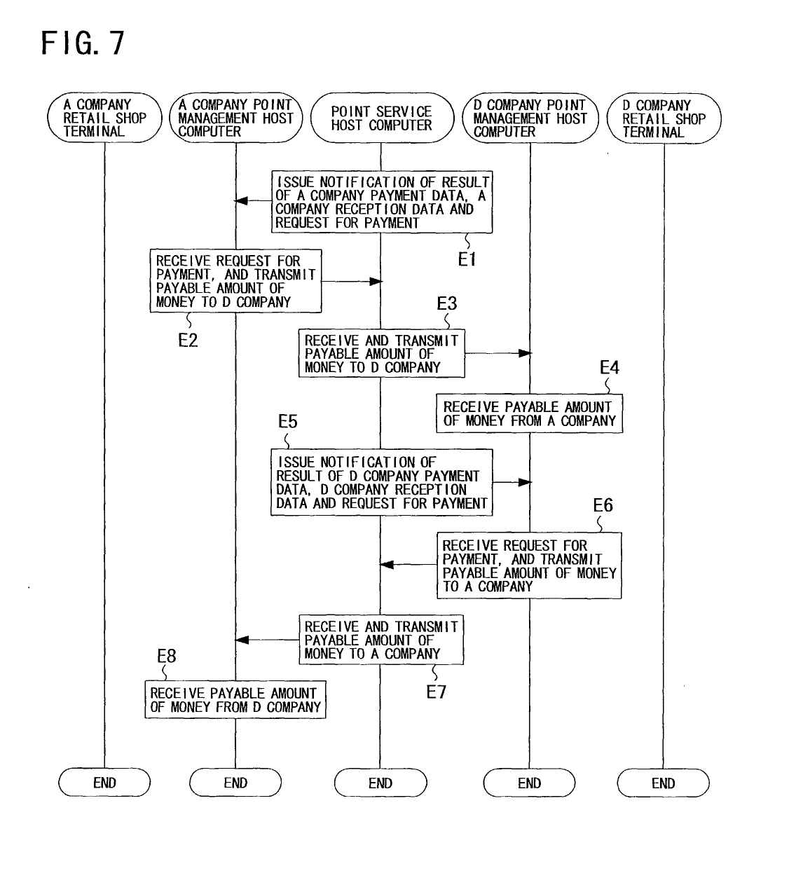

It is to be noted here that the point number added to the point number 340 of the D company through the series of point addition steps described above is a point number to be serviced to the customer 1 by the A company at all due to the fact that the customer 1 purchases a commodity of the A company. Therefore, for the point number serviced to the customer 1 by the A company (that is, added to the point number 340) through the purchase of a commodity of the A company by the customer 1, a corresponding point number need be paid as a point number of the D company from the A company to the D company. Therefore, the point service host computer 100 adds the point number added to the point number 340 of the D company through the series of point addition steps described above as a point service number to be paid from the A company to the D company to the A company payment data 114 and further adds, since the point number is, as viewed from the D company, a point price to be received from the A company, the point number as a price to be received by the D company to the D company reception data 125 (step C18). Payment and reception of point numbers between the A company and the D company are hereinafter described with reference to FIG. 7.

Now, a point addition process when a customer purchases a commodity of the A company using a point card of a company different from the A company which provides a point service in the point system of the first embodiment is described with reference to FIG. 6. In particular, the point addition process is performed when a customer purchases a commodity from one of management enterprises other than the issuing source enterprise from which a customer number has been issued to the customer using a point number accumulated in the issuing source enterprise. FIG. 6 illustrates a flow of a point process when the customer 1 purchases a commodity of the A company indicating its D company point card 550 using a point number accumulated in the D company.

It is assumed that, when the point process illustrated in FIG. 6 is performed, the customer 1 possesses a D company point card 550 and the D company point management host computer 300 has data of the customer number 310, customer name 320, personal identification number 330 and point number 340 with regard to the customer 1 stored in the respective areas of the storage section 302 thereof.

Also it is assumed that the pertaining A company point conversion rate 112 is already stored as a conversion rate to be used for conversion of a point number of the D company into a point number of the A company when a commodity of the A company is purchased with a point number of the point card of the D company in a predetermined area of the storage section 102 based on an agreement concluded in advance between the A company and the D company.

Further, it is assumed that the A company point addition rate 113 is already stored as an addition rate to be used for conversion of a point number to be added by the D company into a point number to be added by the A company when a commodity of the D company is purchased with the point card of the A company in a predetermined area of the storage section 102 based on an agreement concluded in advance between the A company and the D company.

It is to be noted that different conversion tables coordinated with the commodity names 111 may be prepared such that the A company point conversion rates 112 and the A company point addition rates 113 have different values among different commodities or commodity groups to be purchased. In other words, the A company point conversion rate 112 and the A company point addition rate 113 may be stored for each commodity or commodity group to be purchased in a predetermined area of the storage section 102.

Also it is assumed that the pertaining D company point conversion rate 122 is already stored as a conversion rate to be used for conversion of a point number of the A company into a point number of the D company when a commodity of the D company is purchased with a point number of the point card of the A company in a predetermined area of the storage section 102 based on an agreement concluded in advance between the D company and the D company.

Further, it is assumed that the D company point addition rate 123 is already stored as an addition rate to be used for conversion of a point number to be added by the A company into a point number to be added by the D company when a commodity of the A company is purchased with the point card of the D company in a predetermined area of the storage section 102 based on an agreement concluded in advance between the D company and the D company.

It is to be noted that different conversion tables coordinated with the commodity names 121 may be prepared such that the D company point conversion rates 122 and the D company point addition rates 123 have different values among different commodities or commodity groups to be purchased. In other words, the D company point conversion rate 122 and the D company point addition rate 123 may be stored for each commodity or commodity group to be purchased in a predetermined area of the storage section 102.

It is to be noted that, in the following description, if the commodity purchased by the customer 1 is a commodity of the A company, then a point conversion rate A is used for the A company point conversion rate 112 and a point addition rate A is used for the A company point addition rate 113. In other words, values of the A company point conversion rate 112 and the A company point addition rate 113 coordinated with the commodity of the A commodity are used.

When the customer 1 purchases a commodity in a retail shop of the A company, it indicates its D company point card 550. The A company retail shop terminal 400 reads the customer number 551 and the customer name 552 from the D company point card 550 by means of the reading section 401 and receives an input of a personal identification number of the customer 1 through the inputting section 402 (step D1). Then, in order to inquire about the customer 1 and confirm the point number accumulated in the D company point card 550 possessed by the customer 1, the A company retail shop terminal 400 transmits the read customer number 551 and the inputted personal identification number to the A company point management host computer 200 (step D2). The A company point management host computer 200 discriminates from the customer number 551 and the personal identification number received from the A company retail shop terminal 400 that the card of the customer 1 is not an A company point card 450 and transmits the received customer number 551 and personal identification number to the point service host computer 100 (step D3).

The point service host computer 100 transmits the customer number 551 and the personal identification number received from the A company point management host computer 200 to the D company point management host computer 300 in order to inquire about the customer number 551 and the personal identification number (step D4). The D company point management host computer 300 receives the customer number 551 and the personal identification number (step D5), and refers to the customer numbers 310 and the personal identification numbers 330 to specify data of the customer 1 and reads in the point number of the customer 1 in the D company from the pertaining point number 340 and then transmits the point number to the point service host computer 100 (step D6). The point service host computer 100 converts the point number of the customer 1 in the D company received from the D company point management host computer 300 into a point number of the A company with the A company point conversion rate 112 and transmits the point number of the A company to the customer name 220 (step D7).

The A company point management host computer 200 transmits the point number after the conversion received from the point service host computer 100 to the A company retail shop terminal 400 (step D8). After the A company retail shop terminal 400 receives the point number of the customer 1 after the conversion, it calculates an amount of money available for purchase by means of the internal conversion rate 430 and displays the amount of money available for purchase on the display section 403. Then, the A company retail shop terminal 400 confirms whether the customer 1 selects, as a method of payment of the price of the commodity to be purchased, a method wherein the point number stored in the point number 340 is used for the payment or another method wherein the cash or the like is used for the payment of the price of the commodity and a point number provided by the purchase of the commodity is cumulatively added to the point number 340 of the D company. In FIG. 6, it is illustrated that the customer 1 selects the method wherein the point number 340 accumulated through purchases of commodities till then are used for the payment. It is to be noted that the operation of the point system when the method wherein points upon the purchase of the commodity are added to the point number 340 is selected is described hereinabove with reference to FIG. 5.

If the method wherein the point number 340 accumulated in the D company is used for the payment is selected, then the A company retail shop terminal 400 calculates the amount of money which can be used for purchase from the point number of the customer 1 received from the A company point management host computer 200 using the internal conversion rate 430 and displays the amount of money on the display section 403 (step D9). If the customer 1 confirms the displayed amount of money and determines to purchase the commodity with the points (step D10), then the A company retail shop terminal 400 calculates a subtraction point number of the A company to be subtracted from the point number of the customer 1 based on the price of the commodity to be purchased by the customer 1 and transmits the point subtraction number to the A company point management host computer 200 (step D11). The A company point management host computer 200 transmits, since the received point subtraction number is a point subtraction number to be subtracted from the point number 340 for the customer 1 who possesses a card of the D company, the received point subtraction number to the point service host computer 100 (step D12). Since the received point subtraction number is a point number of the A company, the point service host computer 100 converts the received point subtraction number into a point subtraction number of the D company using the A company point conversion rate 112 and transmits the resulting point subtraction number to the D company point management host computer 300 (step D13).

The D company point management host computer 300 subtracts the point subtraction number of the D company received from the point service host computer 100 from the data specified as data of the customer 1 in the point numbers 340 and transmits resulting data to the point service host computer 100 (step D14).

The point service host computer 100 converts, in order to allow the customer 1 to confirm the result of the point subtraction performed, the received point subtraction result into a point number of the A company with the A company point conversion rate 112 and transmits the resulting point number to the A company point management host computer 200 (step D15). The A company point management host computer 200 transmits the received point number to the A company retail shop terminal 400 (step D16). After the point subtraction result in the form of a point number of the A company is received (step D17), the A company retail shop terminal 400 displays the received point addition result as a result of subtraction of a point number from the pertaining point number 340 of the D company when the customer 1 purchases the commodity of the A company indicating the D company point card 550 so that the customer 1 may confirm the point subtraction result (step D18).

It is to be noted here that, although a commodity of the A company is purchased with a point number accumulated in the D company through the series of point processes described above, the service with a point number accumulated in the point number 340 of the D company is performed for the customer 1 who possesses the D company point card 550 at all by the D company. Therefore, for the point number serviced to the customer 1 by the A company (that is, paid as a price of the commodity to be purchased) through the purchase of a commodity of the A company by the customer 1, a corresponding price need be paid from the D company to the A company. In other words, the equivalent to the commodity of the A company need be paid as a corresponding point number for the A company from the D company to the A company. Therefore, the point service host computer 100 adds the point number subtracted from the point number 340 of the D company through the series of point processes described above as a point service number to be paid from the D company to the A company to the D company payment data 124 and further adds, since the point number is, as viewed from the A company, a point price to be received from the D company, the point number as a price to be received by the A company to the A company reception data 115 (step D19). Payment and reception of point numbers between the A company and the D company are described below with reference to FIG. 7.

Now, a payment method and a reception method in settlement of a service price corresponding to a point number between the A company and the D company in the point process when a customer purchases a commodity of the A company indicating a point card of the D company described hereinabove with reference to FIGS. 5 and 6 are described with reference to FIG. 7. In other words, a flow of point processes for payment and reception of an accumulated price upon settlement after transfer of point numbers between enterprises is described. FIG. 7 illustrates a flow of a point process for payment and reception of a service price corresponding to a point number between the A company and the D company when a customer purchases a commodity of the A company indicating a point card of the D company.

The point service host computer 100 stores, in the A company point conversion database 110 thereof, A company payment data 114 which represents an amount of money corresponding to points to be paid from the A company to the D company and A company reception data 115 which represents an amount of money to be received by the A company from the D company. The point service host computer 100 further stores, in the D company point conversion database 120 thereof, D company payment data 124 which represents an amount of money corresponding to points to be paid from the D company to the A company and D company reception data 125 which represents an amount of money to be received by the D company from the A company. It is to be noted that the time for the settlement of the prices is determined in advance in an agreement between the A company and the D company.

When the time for the settlement of the prices comes, the point service host computer 100 first notifies the A company point management host computer 200 of contents of the A company payment data 114 and the A company reception data 115 and issues a request for payment of a price corresponding to the A company payment data 114 (step E1). When the request for payment is received, the A company point management host computer 200 transmits the payable amount of money to the D company to the point service host computer 100 (step E2). The point service host computer 100 receives the payable amount of money and transmits it to the D company point management host computer 300 (step E3). The D company point management host computer 300 receives the payable amount of money and payment of the prices is performed thereby (step E4).

Similarly, when the time for payment of the prices comes, the point service host computer 100 first notifies the D company point management host computer 300 of contents of the D company payment data 124 and the D company reception data 125 and issues a request for payment of an amount of money corresponding to the D company payment data 124 (step E5). The D company point management host computer 300 receives the request for payment and transmits the payable amount of money to the A company to the point service host computer 100 (step E6). The point service host computer 100 receives the payable amount of money and transmits it to the A company point management host computer 200 (step E7). The A company point management host computer 200 receives the payable amount of money and payment of the prices is performed thereby (step E8).

It is to be noted that transmission-reception of an amount of money for the payment described above may be performed in accordance with a payment method such as payment by electronic money based on an agreement concluded in advance.

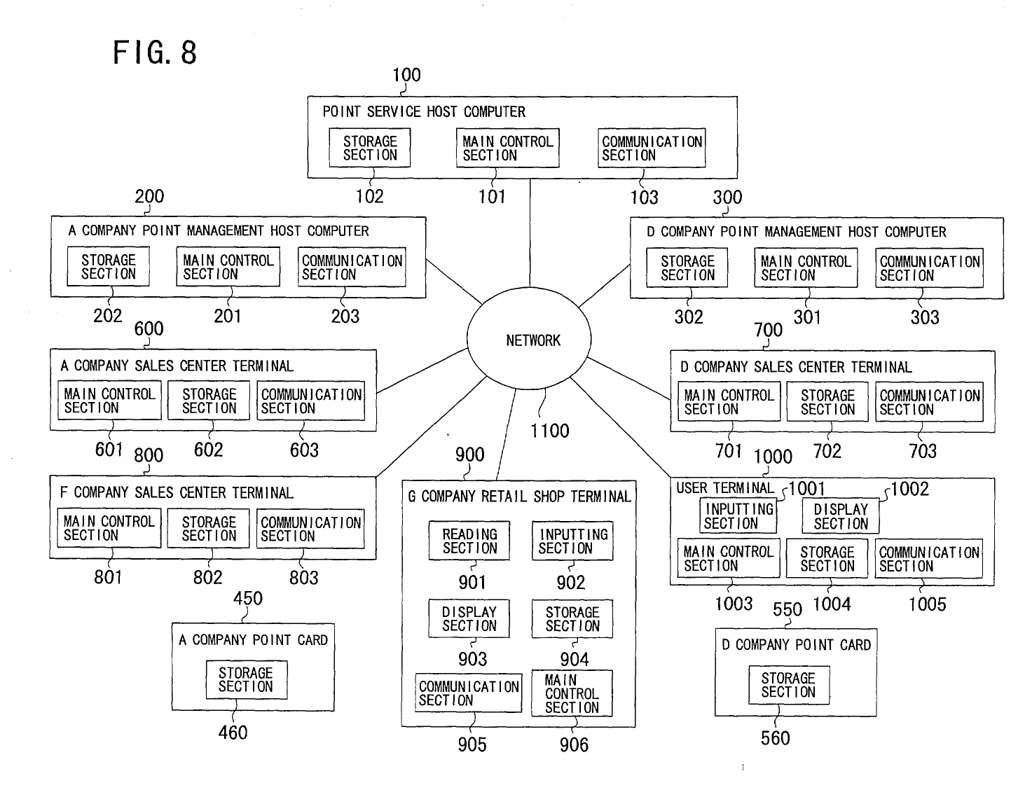

Now, another point system to which the present invention is applied is described. FIG. 8 shows an example of a basic configuration of the point system according to the second embodiment of the present invention.

Referring to FIG. 8, the point system shown includes a point service host computer 100, an A company point management host computer 200 of an A company which provides a point card service, a D company point management host computer 300 of a D company which provides another point card service similarly to the A company, an A company sales center terminal 600, a D company sales center terminal 700, an F company sales center terminal 800 of an F company which does not provide a point card service, a G company retail shop terminal 900 of a G company which does not provide a point card service either, and a user terminal 1000, all connected to a network 1100. A customer who enjoys the point card service of the A company possesses an A company point card 450 while another customer who enjoys the point card service of the D company possesses a D company point card 550.

Each of the A company and the D company is an enterprise (management enterprise) which issues customer numbers to provide a point service and owns a point management host computer to manage the point service of the A company or the D company itself, and therefore is an enterprise (management enterprise) which is a member or participant of the point system of the present embodiment. Meanwhile, the F company and the G company are enterprises (member or participant enterprises) which are members of the point system of the present embodiment, but are not enterprises (management enterprises)which themselves issue customer numbers to manage a point service.

The components of the point system shown in FIG. 8 are individually described below. It is to be noted that overlapping description of common components to those of the point system described hereinabove with reference to FIG. 8 is omitted herein to avoid redundancy.

The A company sales center terminal 600 is formed from an information processing apparatus such as a work station or a server and includes a main control section 601, a storage section 602 and a communication section 603.

The D company sales center terminal 700 is formed from an information processing apparatus such as a work station or a server and includes a main control section 701, a storage section 702 and a communication section 703.

The F company sales center terminal 800 is formed from an information processing apparatus such as a work station or a server and includes a main control section 801, a storage section 802 and a communication section 803.

The main control sections 601, 701 and 801 include each a CPU for controlling the entire information processing apparatus and so forth. The storage sections 602, 702 and 802 store various data and programs. The communication sections 603, 703 and 303 communicate with another information apparatus over the network 1100.

Since the sales center terminals mentioned above may have a known hardware configuration, detailed description thereof is omitted herein.

The G company retail shop terminal 900 includes a reading section 901, an inputting section 902, a display section 903, a storage section 904, a communication section 905 and a main control section 906.

The reading section 901 accepts a point card of a member enterprise which is a member of the point system according to the present invention and reads information stored in the point card. The inputting section 902 is used by a customer to input required information such as a personal identification number. The display section 903 displays a point number at present of the customer and so forth. The storage section 904 stores various data and programs. The communication section 905 communicates with another information apparatus over the network 1100. The main control section 906 controls the entire retail shop terminal of the G company.

It is to be noted that, where the reading section 901 cannot read all point cards of member enterprises using a single reading section, if necessary, it maybe configured additionally including a reading section for exclusive use for reading a point card of an enterprise which cannot be read by the single reading section.

Since the retail shop terminal described above may have a known hardware configuration, detailed description thereof is omitted herein.

The user terminal 1000 includes an inputting section 1001, a display section 1002, a main control section 1003, a storage section 1004 and a communication section 1005.

The inputting section 1001 is used by a customer to input various kinds of information such as a personal identification number. The display section 1002 is a screen of a display unit or the like and displays commodity information or various screens such as an operation screen. The main control section 1003 controls the entire user terminal 1000. The storage section 1004 stores various data and programs. The communication section 1005 communicates with another information apparatus over the network 1100.

Since the user terminal described above may have a known hardware configuration, detailed description thereof is omitted herein.

The point service host computer 100, A company point management host computer 200, D company point management host computer 300, A company sales center terminal 600, D company sales center terminal 700, F company sales center terminal 800, G company retail shop terminal 900 and user terminal 1000 described above are connected to the network 1100 so that they can communicate data with each other over the network 1100. The network 1100 may be any network if it is a computer network for interconnecting information apparatus, and may be, for example, the Internet or a LAN.

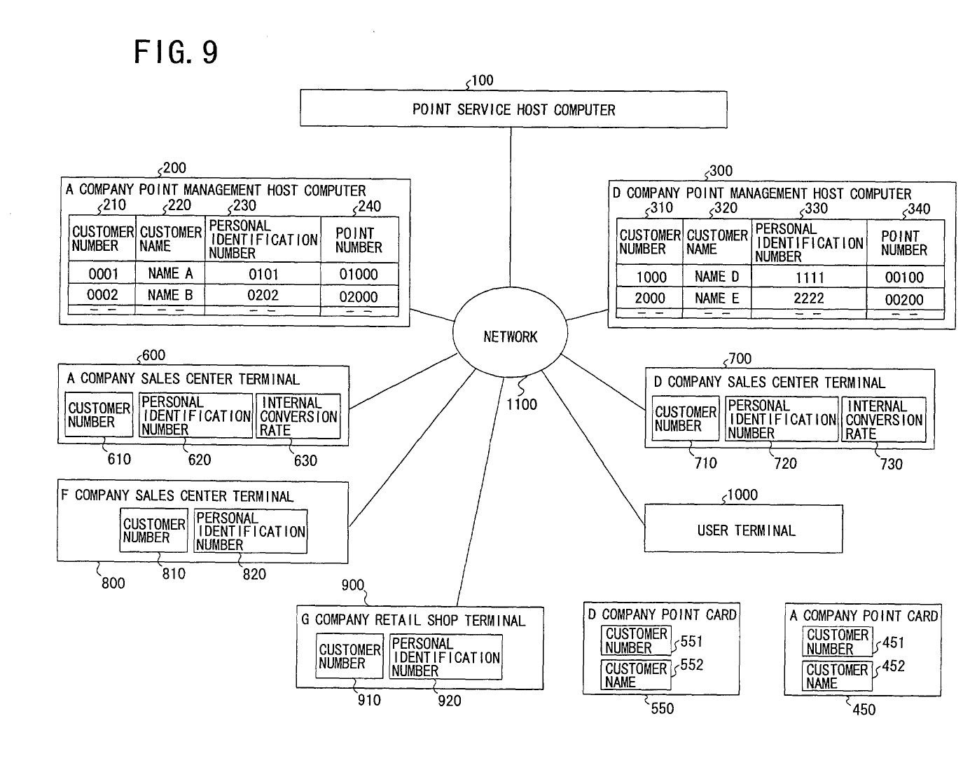

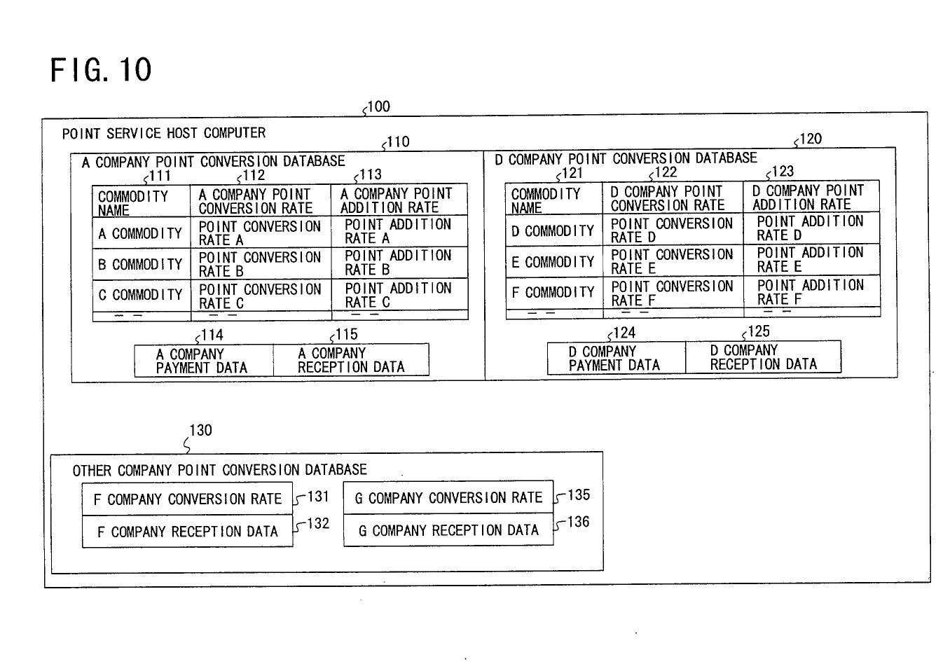

FIG. 9 schematically illustrates data stored in the components of the point system of FIG. 8 except the point service host computer 100, and FIG. 10 schematically illustrates data stored in the point service host computer 100. The components and the data stored in the components are described below with reference to FIGS. 9 and 10.

The point service host computer 100 integrates the services of the companies which provide point card services and includes an A company point conversion database 110 for storing information of the point cards of the A company, a D company point conversion database 120 for storing information of the point cards of the D company, and an other company point conversion database 130 for storing information regarding conversion of points of those enterprises which themselves do not provide a point service (which are member companies of the point system but are not management enterprises).

The A company point conversion database 110 stores commodity names 111, A company point conversion rates 112, A company point addition rates 113, A company payment data 114 and A company reception data 115.

Each of the A company point conversion rates 112 indicates a conversion rate to be used for conversion between a point number of the D company and a point number of the A company when a customer purchases a commodity of the A company with points of a point card of any other management enterprise (the D company) than the A company. In particular, each A company point conversion rate 112 indicates a point conversion rate between the A company and the D company upon point conversion other than point conversion in the case wherein, when a customer purchases a commodity of the A company indicating a customer number 551 issued by the D company, a point number corresponding to the amount of money required for the purchase is added to a point number accumulated already. Such A company point conversion rates 112 are stored in a coordinated relationship with the commodity names 111 of the A company in respective storage areas of the storage section 102. The values of the A company point conversion rates 112 are decided in an agreement between the A company and the D company concluded in advance in order to allow point cards to be utilized between the A company and the D company.

Each of the A company point addition rates 113 indicates an addition rate to be used for conversion of a point number to be added in the D company into a point number to be added in the A company when a customer purchases a commodity of the A company with a point card of any other management enterprise (the D company) than the A company. In particular, each A company point addition rate 113 indicates a conversion rate between the A company and the D company in the case wherein a point number corresponding to the amount of money required for the purchase is added to a point number accumulated already when a customer purchases a commodity of the A company indicating the customer number 551 issued by the D company. Such A company point addition rates 113 are stored in a coordinated relationship with the commodity names 111 of the A company in respective storage areas of the storage section 102. The values of the A company point addition rates 113 are decided in an agreement between the A company and the D company concluded in advance similarly to the values of the A company point conversion rate 112.

The A company payment data 114 indicates an amount of money to be paid by the A company upon settlement between the A company and a member company other than the A company after a point service is performed with a number of points converted into a number of points of a management company other than the A company or into an amount of money available for purchase with some other member enterprise. In particular, upon settlement after point numbers (point services) are transferred between the enterprises, the value of an amount of money to be paid by the A company is accumulated into the pertaining A company payment data 114. In other words, the point service host computer 100 functions as payable money amount storage means. The time for such settlement is decided in advance.

The A company reception data 115 indicates an amount of money to be received by the A company upon settlement between the A company and a management enterprise (the D company) other than the A company after a point service is performed with the point service converted into a point number of the opposite company. In particular, the value of an amount of money to be received by the A company upon settlement after point numbers (point services) are transferred between the enterprises is stored into the A company reception data 115. In other words, the point service host computer 100 functions as receivable money amount storage means. The time for such settlement is decided in advance.

The D company point conversion database 120 stores commodity names 121, D company point conversion rates 122, D company point addition rates 123, D company payment data 124 and D company reception data 125.

Each of the D company point conversion rates 122 indicates a conversion rate to be used for conversion of a point number of the A company into a point number of the D company when a customer purchases a commodity of the D company with points of a point card of a management enterprise (the A company) other than the D company. In particular, each D company point conversion rate 122 indicates a point conversion rate between the A company and the D company upon point conversion other than point conversion in the case wherein, when a customer purchases a commodity of the D company indicating a customer number 451 issued by the A company, a point number corresponding to the amount of money required for the purchase is added to a point number accumulated already. Such D company point conversion rates 122 are stored in a coordinated relationship with the commodity names 121 of the D company in respective storage areas of the storage section 102. The values of the D company point conversion rates 122 are decided in an agreement between the A company and the D company concluded in advance in order to allow point cards to be utilized between the A company and the D company.

Each of the D company point addition rates 123 indicates an addition rate to be used for conversion of a point number to be added in the A company into a point number to be added in the D company when a customer purchases a commodity of the D company with a point card of a management enterprise (the A company) other than the D company. In particular, each D company point addition rate 123 indicates a conversion rate between the A company and the D company in the case wherein a point number corresponding to the amount of money required for the purchase is added to a point number accumulated already when a customer purchases a commodity of the D company indicating the customer number 451 issued by the A company. Such D company point addition rates 123 are stored in a coordinated relationship with the commodity names 121 of the D company in respective storage areas of the storage section 102. The values of the D company point addition rates 123 are decided in an agreement between the A company and the D company concluded in advance similarly to the values of the D company point conversion rate 122.

The D company payment data 124 indicates an amount of money to be received by the D company upon settlement between the D company and a management enterprise (the A company) other than the D company after a point service is performed with the point number converted into a number of points of the opposite company. In particular, upon settlement after point numbers (point services) are transferred between the enterprises, the value of an amount of money to be paid by the D company is stored into the D company payment data 124. In other words, the point service host computer 100 functions as payable money amount storage means. The time for such settlement is decided in advance.

The D company reception data 125 indicates an amount of money to be received by the D company upon settlement between the A company and a management enterprise (the A company) other than the D company after a point service is performed with the point service converted into a number of points of the opposite company. In particular, the value of an amount of money to be received by the D company upon settlement after point numbers (point services) are transferred between the enterprises is stored into the D company reception data 125. In other words, the point service host computer 100 functions as receivable money amount storage means. The time for such settlement is decided in advance.

The other company point conversion database 130 stores conversion rates and reception data of those enterprises which are member enterprises but are not management enterprises. More particularly, the other company point conversion database 130 stores an F company conversion rate 131, an F company reception data 132, a G company conversion rate 135 and a G company reception data 136.

The F company conversion rate 131 indicates a conversion rate to be used for conversion between a point number of a management company (the A company or the D company) and an amount of money for the F company when a customer purchases a commodity of the F company with points of a point card of the management enterprise. In particular, the F company conversion rate 131 indicates a conversion rate for conversion of a purchase amount of money in the F company into a point number of one of the management enterprises (the A company and the D company) and for conversion of a point number of the management enterprise into an amount of money available for purchase in the F company when a customer purchases a commodity of the F company with a number of points of a point card-of the management enterprise. Such F company conversion rates 131 maybe stored in a coordinated relationship with commodities of the F company in respective storage areas of the storage section 102. The values of the F company conversion rates 131 are decided in an agreement between the F company and the management enterprise concluded in advance.

The F company reception data 132 indicates an amount of money to be received by the F company upon settlement after a customer purchases a commodity of the F company with points of a point card of a management enterprise (the A company or the D company). In particular, the F company reception data 132 indicates a value of an amount of money to be received by the F company upon settlement after point services (point numbers) are transferred between the enterprises. In other words, the point service host computer 100 functions as receivable money amount storage means. The time of the settlement may be immediately after the purchase by the customer or may be decided in an agreement concluded in advance.

The G company conversion rate 135 indicates a conversion rate to be used for conversion between a point number of a management company (the A company or the D company) and an amount of money for the G company when a customer purchases a commodity of the G company with points of a point card of the management enterprise. In particular, the G company conversion rate 135 indicates a conversion rate for conversion of a purchase amount of money in the G company into a point number of one of the management enterprises (the A company and the D company) and for conversion of a point number of the management enterprise into an amount of money available for purchase in the G company when a customer purchases a commodity of the G company with a number of points of a point card of the management enterprise. Such G company conversion rates 135 maybe stored in a coordinated relationship with commodities of the G company in respective storage areas of the storage section 102. The values of the G company conversion rates 135 are decided in an agreement between the G company and the management enterprise concluded in advance.

The G company reception data 136 indicates an amount of money to be received by the F company upon settlement after a customer purchases a commodity of the G company with points of a point card of a management enterprise (the A company or the D company). In particular, the G company conversion rate 135 indicates a value of an amount of money to be received by the G company upon settlement after point services (point numbers) are transferred between the enterprises. In other words, the point service host computer 100 functions as receivable money amount storage means. The time of the settlement may be immediately after the purchase by the customer or may be decided in an agreement concluded in advance.

The A company point management host computer 200 stores customer numbers 210, customer names 220, personal identification numbers 230 and point numbers 240 as customer data for a service of the point cards by the A company in a coordinated relationship with the data of the customer numbers 210 in respective areas of the storage section 202.

The D company point management host computer 300 stores customer numbers 310, customer names 320, personal identification numbers 330 and point numbers 340 as customer data for a service of the point cards by the D company in a coordinated relationship with the data of the customer numbers 310 in respective areas of the storage section 302.

The A company sales center terminal 600 isused by a seller of products of the A company and stores a customer number 610, a personal identification number 620 and an internal conversion rate 630 for conversion between a point number of the A company and an amount of money transmitted thereto over the network 1100 in respective areas of the storage section 602. The internal conversion rate (point/money amount conversion rate) 630 particularly is a conversion rate with which, when a customer purchases a commodity of the A company, the amount of money for the purchase is converted into a point number of the A company and, when a customer uses a point number to purchase a commodity of the A company, the point number of the A company is converted into an amount of money which can be used for the purchase in the A company.

The D company sales center terminal 700 is used by a seller of products of the D company and stores a customer number 710, a personal identification number 720 and an internal conversion rate 730 for conversion between a point number of the D company and an amount of money transmitted thereto over the network 1100 in respective areas of the storage section 702. The internal conversion rate (point/money amount conversion rate) 730 particularly is a conversion rate with which, when a customer purchases a commodity of the D company, the amount of money for the purchase is converted into a point number of the D company and, when a customer uses a point number to purchase a commodity of the D company, the point number of the D company is converted into an amount of money which can be used for the purchase in the D company.

The F company sales center terminal 800 is used by a seller of products of the F company and stores a customer number 810 and a personal identification number 820 transmitted thereto over the network 1100 in respective areas of the storage section 802.

The G company retail shop terminal 900 stores, in respective areas of the storage section 904 thereof, a customer number 910 read by the reading section 901 from a point card of a management enterprise which provides a point service and a personal identification number 920 inputted from the inputting section 902.

The user terminal 1000 is a terminal used by a customer to access another information terminal over the network 1100, and particularly can access product information (commodity information) and/or sales information laid open on the network 1100 by the A company sales center terminal 600, D company sales center terminal 700 or F company sales center terminal 800 and display the accessed product information or a purchase screen on the display section 1002. A customer may refer to the displayed contents of the display section 1002 and input a selected desired commodity to be purchased and information regarding a point card or a credit card as means for payment using the inputting section 1001. The user terminal 1000 notifies a sales center terminal of an enterprise, which sells the desired commodity, of the thus inputted information under the control of the main control section 1003 using the communication section 1005.

The A company point card 450 stores a customer number 451 issued by the A company and a customer name 452 of a customer who possesses the A company point card 450 as information for specifying the customer in predetermined areas of the storage section 460. Also the D company point card 550 similarly stores a customer number 551 issued by the D company and a customer name 552 of the customer in predetermined areas of the storage section 560.

As described above, in the example of the configuration of the point system according to the second embodiment, a customer number, a customer name, a personal identification number and a point number of a customer who possesses an A company point card 450 (that is, to whom the customer number has been issued from the A company) are stored only in the A company point management host computer 200. Similarly, a customer number, a customer name, a personal identification number and a point number of a customer who possesses a D company point card 550 (that is, to whom the customer number has been issued from the D company) are stored only in the D company point management host computer 300. In other words, customer information of each management enterprise is stored only in the point management host computer of the management enterprise.

Since the point system according to the second embodiment is configured in such a manner as described above, the point service host computer 100 functions as first conversion means in the A company by converting a point number of a particular customer from among the point numbers 340 of the D company point management host computer 300 with the pertaining A company point addition rate 113.

Further, the point service host computer 100 functions as first conversion means in the D company by converting a point number of a particular customer from among the point numbers 240 of the A company point management host computer 200 with the pertaining D company point addition rate 123.

Further, the point service host computer 100 functions as second conversion means in the A company by converting a point number of a particular customer from among the point numbers 340 of the D company point management host computer 300 with the pertaining A company point conversion rate 112.

Furthermore, the point service host computer 100 functions as second conversion means in the D company by converting a point number of a particular customer from among the point numbers 240 of the A company point management host computer 200 with the pertaining D company point conversion rate 122.

Further, the point service host computer 100 performs conversion between a point number of a certain management enterprise (the A company or the D company) and an amount of money in the F company with the F company conversion rate 131. Thus, the point service host computer 100 functions as third conversion means in the F company. In particular, the point service host computer 100 converts a purchase amount of money in the F company into a point number of a management enterprise using the F company conversion rate 131, and converts a point number of a certain management enterprise into an amount of money available for purchase from the F company using the F company conversion rate 131, thereby functioning as third conversion means of the F company.

Furthermore, the point service host computer 100 performs conversion between a point number of a certain management enterprise (the A company or the D company) and an amount of money for the G company with the G company conversion rate 135. Thus, the point service host computer 100 functions as third conversion means in the G company. In particular, the point service host computer 100 converts a purchase amount of money in the G company into a point number of a management enterprise using the G company conversion rate 135, and converts a point number of a certain management enterprise into an amount of money available for purchase from the G company using the G company conversion rate 135, thereby functioning as third conversion means of the G company.

Now, operation of the point system according to the second embodiment is described.

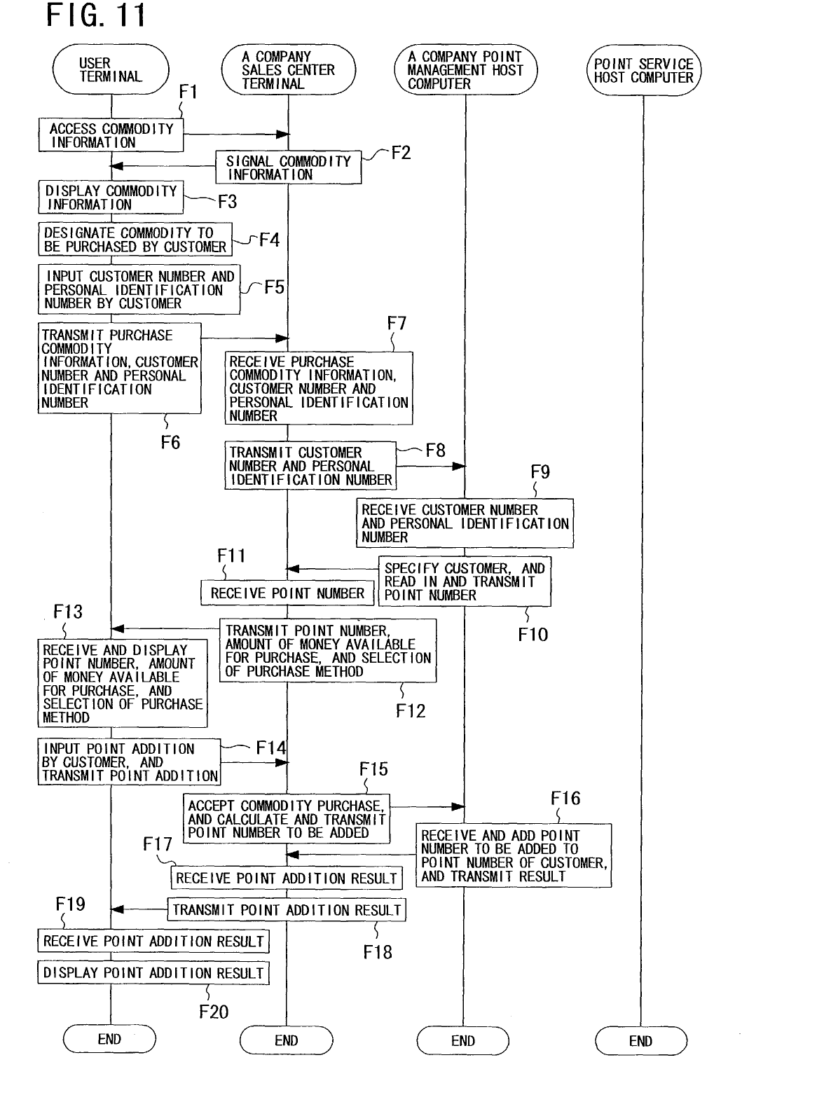

FIG. 11 illustrates a procedure of a point addition process when a customer 1 who possesses an A company point card 450 uses the user terminal 1000 to purchase a commodity from the A company sales center terminal (sales terminal of the enterprise which sells the commodity) 600 over the network 1100 and a point number to be serviced to the customer 1 from the A company in response to the purchase is added to a point number of the A company (that is, a point number to be accumulated into the A company point management host computer 200). When a commodity of the A company is purchased, points corresponding the purchased commodity are added as points of the A company which is an enterprise which has issued the pertaining customer number in a similar manner as in conventional addition of points. Thus, operation of the point system when the point process then is performed is described below with reference to FIG. 11.

First, the customer 1 may operate the user terminal 1000 to access commodity information laid open by the A company sales center terminal 600 over the network 1100 (step F1). The A company sales center terminal 600 signals such commodity information to the user terminal 1000 over the network 1100 in response to the access (step F2). The user terminal 1000 receives and displays the commodity information on the display section 1002 (step F3). After the customer 1 determines a commodity to be purchased based on the displayed commodity information, it may operate the inputting section 1001 to designate (register) a commodity to be purchased (step F4) and input the customer number 451 of the A company point card 450 possessed thereby and a personal identification number (step F5). In response to the input, the user terminal 1000 transmits the inputted purchase commodity information, customer number 451 and personal identification number to the A company sales center terminal 600 (step F6).

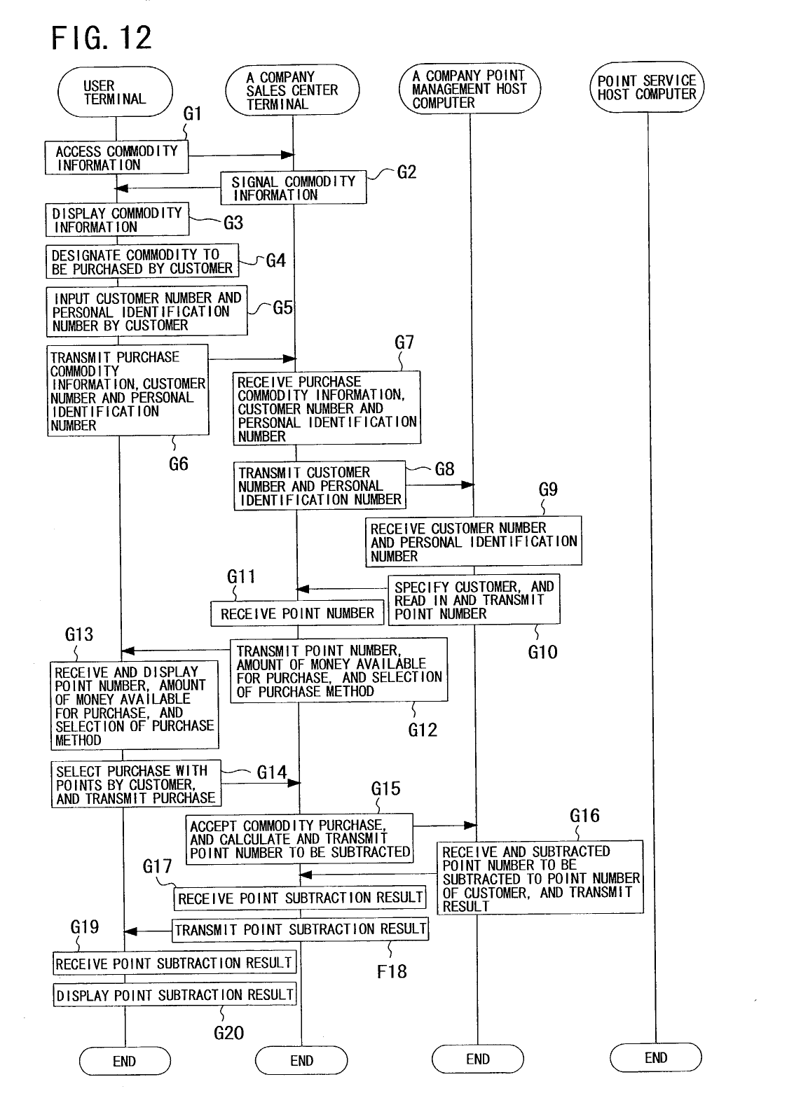

The A company sales center terminal 600 receives the purchase commodity information, customer number 451 and personal identification number sent thereto from the user terminal 1000 (step F7) and transmits the customer number 451 and the personal identification number to the A company point management host computer 200 in order to inquire about the customer number 451 and the personal identification number (step F8). The A company point management host computer 200 receives the customer number 451 and the personal identification number (step F9), and collates the received customer number 451 and personal identification number with the customer numbers 210 and the personal identification numbers 230, respectively, to specify the customer and reads in the point number of the specified customer from the point numbers 240 and then transmits the point number to the A company sales center terminal 600 (step F10). The A company sales center terminal 600 receives the point number of the customer 1 (step F11) and transmits the received point number of the customer 1, an available amount of money for purchase of the commodity calculated from the point number with the internal conversion rate 630 and information regarding selection of a purchase method of the commodity to the user terminal 1000 in order to confirm whether the customer 1 uses, as a method of payment for the commodity to be purchased by the customer 1, a method wherein the point number accumulated till then is used for the payment or another method wherein the cash or a credit card is used for the payment for the commodity and points involved in the purchase of the commodity are added to the point number accumulated till then (step F12). The user terminal 1000 displays the received point number of the customer 1, the amount of money which can be used to purchase the commodity based on the point number and the information regarding the selection of the purchasing method of the commodity on the display section 1002 (step F13) so that they may be confirmed by the customer 1. In FIG. 11, it is illustrated that the customer 1 selects the method where in points upon purchase of the commodity are added to the point number 240 accumulated till then. It is to be noted that, payment where the point number accumulated in the point number 240 is used is hereinafter described with reference to FIG. 12.

If the method wherein points are added to the point number 240 is selected, then the user terminal 1000 transmits the information of the purchased commodity, the point addition information and the information of the method of payment of the price inputted by the customer 1 to the A company sales center terminal 600(step F14). After the A company sales center terminal 600 receives the information of the purchased commodity and so forth, it calculates a point number to be added from the price of the purchased commodity with the internal conversion rate 630 and transmits the calculated point number to be added to the A company point management host computer 200 (step F15). After the A company point management host computer 200 receives the point number to be added, it adds the received point number to the point number specified as a point number of the customer 1 in the point numbers 240 and transmits a result of the addition to the A company sales center terminal 600 (step F16). After the A company sales center terminal 600 receives the point addition result to the point number of the customer 1 from the A company point management host computer 200 (step F17), it transmits the addition result to the user terminal 1000 (step F18). The user terminal 1000 receives the point addition result (step F19) and displays it on the inputting section 1001 so that it may be confirmed by the customer 1 (step F20).

FIG. 12 illustrates a procedure of a point process when a customer 1 who possesses an A company point card 450 uses the user terminal 1000 to purchase a commodity from the A company sales center terminal 600 (sales terminal of the enterprise which sells the commodity) over the network 1100 and pays the price of the commodity using a point number of the A company accumulated till then by the customer 1 (that is, a point number of the customer 1 accumulated in the A company point management host computer 200). It is a process similar to a conventional point process that, when a commodity of the A company is purchased, a point number accumulated in the A company which is an enterprise which has issued a customer number is used to pay the price of the commodity to the A company. Thus, operation of the point system when the point process then is performed is described below with reference to FIG. 12.

First, the customer 1 may operate the user terminal 1000 to access commodity information laid open by the A company sales center terminal 600 over the network 1100 (step G1). The A company sales center terminal 600 signals such commodity information to the user terminal 1000 over the network 1100 in response to the access (step G2). The user terminal 1000 receives and displays the commodity information on the display section 1002 (step G3). After the customer 1 determines a commodity to be purchased based on the displayed commodity information, it may input the customer number 451 of the A company point card 450 possessed thereby and a personal identification number (step G5). In response to the input, the user terminal 1000 transmits the inputted purchase commodity information, customer number 451 and personal identification number to the A company sales center terminal 600 (step G6).

The A company sales center terminal 600 receives the purchase commodity information, customer number 451 and personal identification number sent thereto from the user terminal 1000 (step G7) and transmits the customer number 451 and the personal identification number to the A company point management host computer 200 in order to inquire about the customer number 451 and the personal identification number(step G8). The A company point management host computer 200 receives the customer number 451 and the personal identification number (step G9), and collates the received customer number 451 and personal identification number with the customer numbers 210 and the personal identification numbers 230, respectively, to specify the customer and reads in the point number of the specified customer from the point numbers 240 and then transmits the point number to the A company sales center terminal 600 (step G10). The A company sales center terminal 600 receives the point number of the customer 1 (step G11) and transmits the received point number of the customer 1, an amount of money available for purchase of the commodity calculated from the point number with the internal conversion rate 630 and information regarding selection of a purchase method of the commodity to the user terminal 1000 in order to confirm whether the customer 1 uses, as a method of payment for the commodity to be purchased by the customer 1, a method wherein the point number accumulated till then is used for the payment or another method wherein the cash or a credit card is used for the payment for the commodity (step G12). The user terminal 1000 displays the received point number of the customer 1, an amount of money which can be used to purchase the commodity and the information regarding the selection of the purchasing method of the commodity on the display section 1002 (step G13) so that they may be confirmed by the customer 1. In FIG. 12, it is illustrated that the customer 1 selects the method wherein the point number in the point number 240 accumulated through purchases of commodities till then by the customer 1 is used for the payment. It is to be noted that the payment where points upon purchase of the commodity are added to the point number 240 is described hereinabove with reference to FIG. 11.

If the method wherein the point number accumulated in the point number 240 is used for the payment is selected, then the user terminal 1000 transmits the information of the purchased commodity, information of the amount of money (point number) which can be used for the purchase and the information of the method of payment of the price (selection of the payment based on points) inputted by the customer 1 to the A company sales center terminal 600 (step G14). After the A company sales center terminal 600 receives the information of the purchased commodity and so forth, it calculates a point number to be subtracted from the price of the purchased commodity with the internal conversion rate 630 and transmits the calculated point number to be subtracted to the A company point management host computer 200 (step G15). After the A company point management host computer 200 receives the point number to be subtracted, it subtracts the received point number from the point number specified as a point number of the customer 1 in the point numbers 240 and transmits a result of the subtraction to the A company sales center terminal 600 (step G16). After the A company sales center terminal 600 receives the point subtraction result of the customer 1 from the A company point management host computer 200 (step G17), it transmits the subtraction result to the user terminal 1000 (step G18). The user terminal 1000 receives the point subtraction result (step G19) and displays it on the inputting section 1001 so that it maybe confirmed by the customer 1 (step G20).

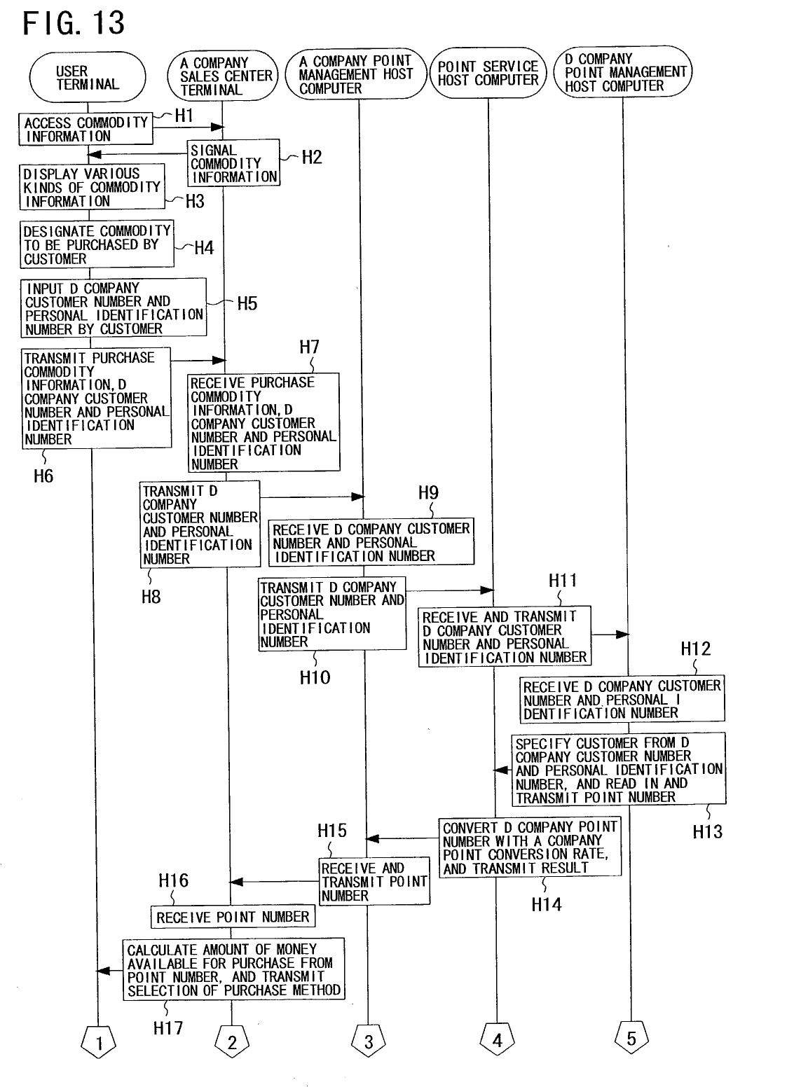

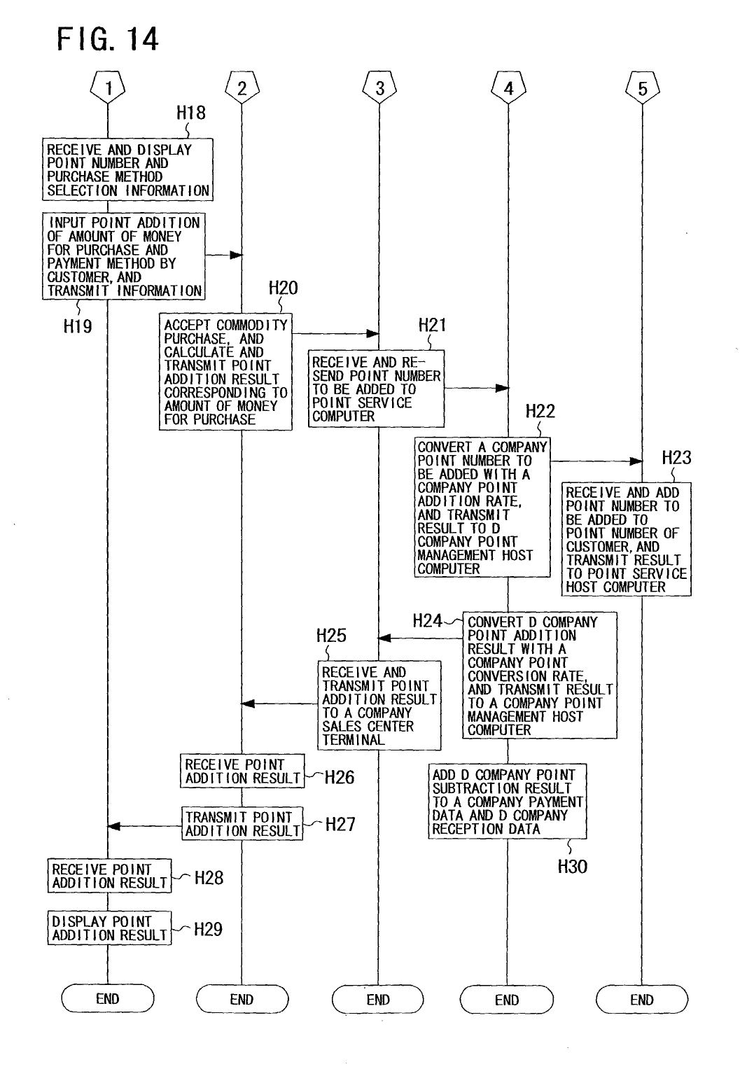

Subsequently, a point addition process of the point system of the second embodiment when a customer makes use of a network to purchase a commodity of the A company using a point card of a company which provides a point service other than the A company is described with reference to FIGS. 13 and 14. In other words, the point addition process is performed when a customer purchases a commodity making use of a network from a commodity selling source enterprise which is one of management enterprises other than a management enterprise which has issued a customer number and points involved in the purchase are accumulated in the commodity selling source enterprise. FIGS. 13 and 14 illustrate a flow of the point process where the customer 1 inputs the customer number 551 of a D company point card 550 thereof and uses a user terminal to purchase a commodity of the A company over a network.

It is assumed that, when the point addition process illustrated in FIGS. 13 and 14 is performed, the customer 1 possesses a D company point card 550 and the D company point management host computer 300 has data of the customer number 310, customer name 320, personal identification number 330 and point number 340 with regard to the customer 1 stored in the respective areas of the storage section 302 thereof.

Also it is assumed that the pertaining A company point conversion rate 112 is already stored as a conversion rate to be used for conversion of a point number of the D company into a point number of the A company when a commodity of the A company is purchased with a point number of the point card of the D company in a predetermined area of the storage section 102 based on an agreement concluded in advance between the A company and the D company.

Further, it is assumed that the A company point addition rate 113 is already stored as an addition rate to be used for conversion of a point number to be added by the D company into a point number to be added by the A company when a commodity of the D company is purchased with the point card of the A company in a predetermined area of the storage section 102 based on an agreement concluded in advance between the A company and the D company.

It is to be noted that different conversion tables coordinated with the commodity names 111 may be prepared such that the A company point conversion rates 112 and the A company point addition rates 113 have different values among different commodities or commodity groups to be purchased. In other words, the A company point conversion rate 112 and the A company point addition rate 113 may be stored for each commodity or commodity group to be purchased in a predetermined area of the storage section 102.

Also it is assumed that the pertaining D company point conversion rate 122 is already stored as a conversion rate to be used for conversion of a point number of the A company into a point number of the D company when a commodity of the D company is purchased with a point number of the point card of the A company in a predetermined area of the storage section 102 based on an agreement concluded in advance between the D company and the D company.

Further, it is assumed that the D company point addition rate 123 is already stored as an addition rate to be used for conversion of a point number to be added by the A company into a point number to be added by the D company when a commodity of the A company is purchased with the point card of the D company in a predetermined area of the storage section 102 based on an agreement concluded in advance between the D company and the D company.

It is to be noted that different conversion tables coordinated with the commodity names 121 may be prepared such that the D company point conversion rates 122 and the D company point addition rates 123 have different values among different commodities or commodity groups to be purchased. In other words, the D company point conversion rate 122 and the D company point addition rate 123 may be stored for each commodity or commodity group to be purchased in a predetermined area of the storage section 102.

It is to be noted that, in the following description, if the commodity purchased by the customer 1 is a commodity of the A company, then a point conversion rate A is used for the A company point conversion rate 112 and a point addition rate A is used for the A company point addition rate 113. In other words, values of the A company point conversion rate 112 and the A company point addition rate 113 coordinated with the commodity of the A commodity are used.

First, the customer 1 may operate the user terminal 1000 to access commodity information laid open by the A company sales center terminal 600 over the network 1100 (step H1). The A company sales center terminal 600 signals such commodity information to the user terminal 1000 over the network 1100 (step H2). The user terminal 1000 receives and displays the commodity information on the display section 1002 (step H3). The customer 1 may designate a commodity to be purchased from within the screen displayed on the display section 1002 (step H4) and input the customer number 551 of the D company point card 550 possessed thereby and a personal identification number (step H5). The user terminal 1000 transmits the inputted purchase commodity information, customer number 551 and personal identification number to the A company sales center terminal 600 (step H6).

The A company sales center terminal 600 receives the purchase commodity information, customer number 551 and personal identification number (step H7) and transmits the customer number 551 and the personal identification number of the customer 1 to the A company point management host computer 200 in order to inquire about the customer number 551 and the personal identification number (step H8).

The A company point management host computer 200 receives the purchased commodity information, customer number 551 and personal identification number (step H9). However, since received customer information is the customer number 551 of the D company and the personal identification number, the A company point management host computer 200 cannot collate the customer information. Therefore, the A company point management host computer 200 transmits the customer number 551 and the personal identification number to the point service host computer 100 (step H10). The point service host computer 100 receives the customer number 551 and the personal identification numbers and sends them to the D company point management host computer 300 in order to inquire about the customer number 551 of the D company and the personal identification number received (step H11).

The D company point management host computer 300 receives the customer number 551 and the personal identification number from the point service host computer 100 (step H12) and collates the received customer number 551 and personal identification number with the customer numbers 310 and the personal identification numbers 330, respectively, and then reads in the point number of the customer specified as a result of the collation from the point numbers 340. Then, the D company point management host computer 300 transmits the point number of the customer 1 in the D company thus read in to the point service host computer 100 (step H13).

The point service host computer 100 converts the point number of the D company received from the D company point management host computer 300 into a point number of the A company with the A company point conversion rate 112 and transmits the resulting point number of the A company to the A company point management host computer 200 (step H14). The A company point management host computer 200 transmits the received point number of the A company to the A company sales center terminal 600 (step H15).

The A company sales center terminal 600 receives the point number of the A company (step H16) and calculates an amount of money available for purchase in the A company based on a point number accumulated till then from the received point number of the A company with the internal conversion rate 630. Then, the A company sales center terminal 600 transmits the received point information of the card (point number accumulated till then and available for purchase), the amount of money available for purchase based on the point number and in formation regarding selection of a purchase method of the commodity to the user terminal 1000 in order to confirm whether the customer 1 uses, as a method of payment for the commodity to be purchased by the customer 1, a method wherein the point number accumulated till then is used for the payment or another method wherein the cash or a credit card is used for the payment for the commodity and points involved in the purchase of the commodity are added to the points accumulated till then (step H17).

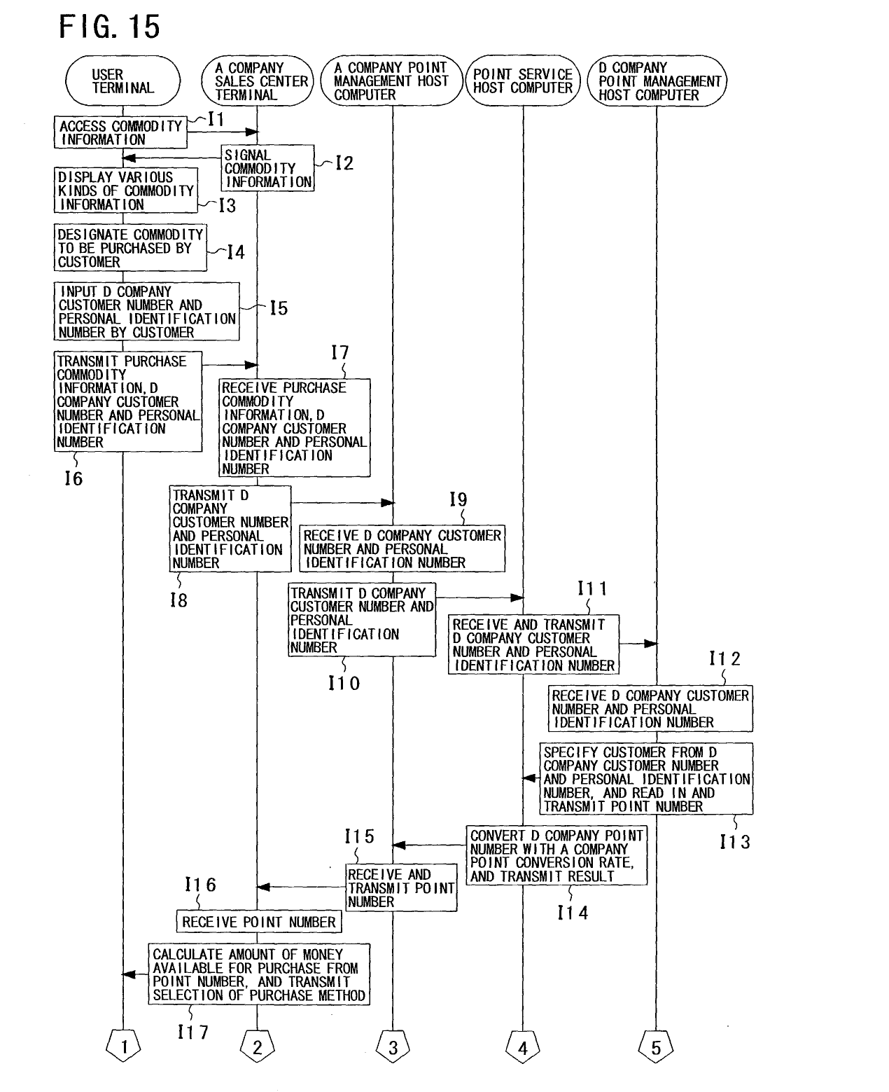

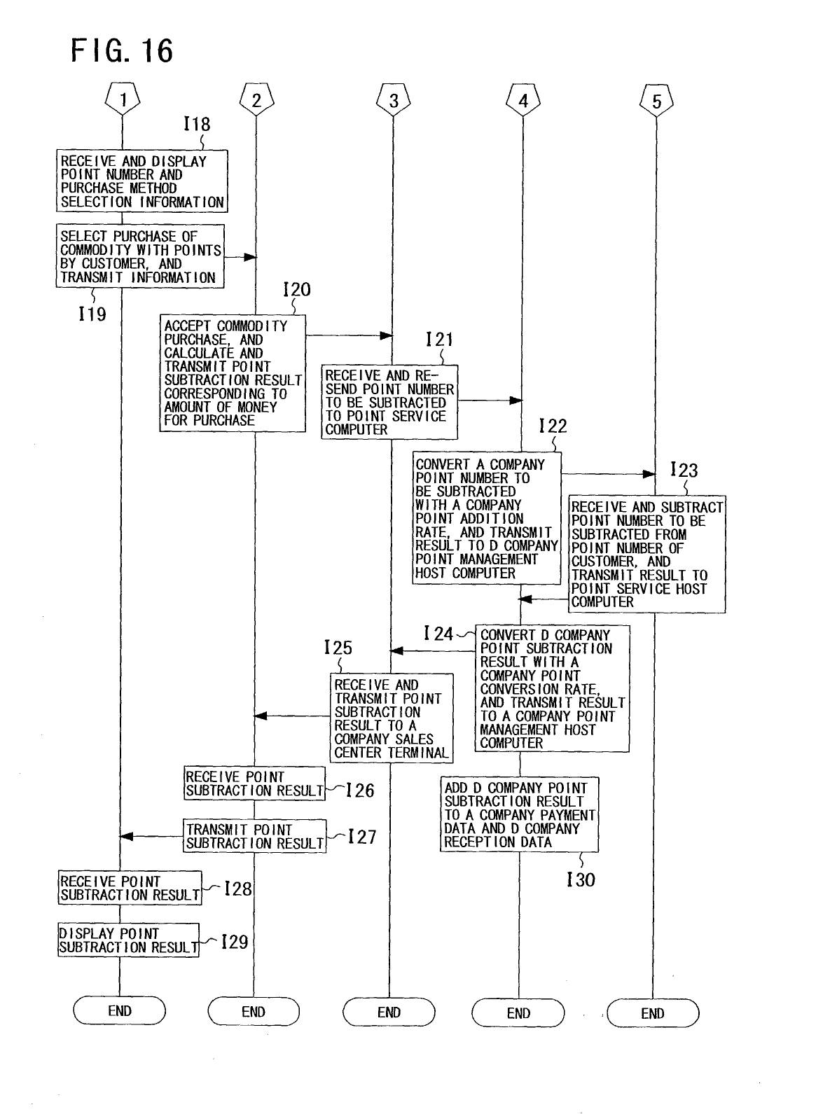

The user terminal 1000 receives the point number accumulated till then and available for purchase, the amount of money available for purchase based on the point number and the information regarding selection of a purchase method of the commodity and displays them on the display section 1002 to urge the customer 1 to select a purchase method (step H18). In FIGS. 13 and 14, it is illustrated that the customer 1 selects the method wherein points upon purchase of the commodity are added to the point number 340 accumulated till then. It is to be noted that payment where the point number accumulated in the point number 340 is used is hereinafter described with reference to FIGS. 15 and 16.

If the method wherein points are added to the point number 340 is selected, then the user terminal 1000 transmits the information of the purchased commodity of the customer 1, the point addition information (that addition of points is selected) and the information of the method of payment of the price to the A company sales center terminal 600 (step H19). After the A company sales center terminal 600 receives the information of the purchased commodity and so forth, it calculates a point number to be added from the price of the purchased commodity with the internal conversion rate 630 and transmits the calculated point number to be added to the A company point management host computer 200 (step H20).

After the A company point management host computer 200 receives the point number to be added to the customer 1, since the received point number to be added is for the customer of the point card of the D company, the A company point management host computer 200 transmits the received point number to the point service host computer 100 (step H21). Since the received point number to be added is a point number of the A company, the point service host computer 100 converts the point number into a point number of the D company with the A company point addition rate 113 and transmits the resulting point number to the D company point management host computer 300 (step H22).

The D company point management host computer 300 adds the point number received from the point service host computer 100 to the point number in the point numbers 340 specified as a point number of the customer 1 as a result of the inquiry and transmits a result of the addition to the point service host computer 100 (step H23). After the point service host computer 100 receives the point addition result, it converts, in order to allow the customer 1 to confirm the point addition result, the received point addition result into a point addition result in the form of a point number of the A company with the A company point conversion rate 112 and transmits the resulting point addition result to the A company point management host computer 200 (step H24). The A company point management host computer 200 receives the point addition result in the form of a point number of the A company and transmits it to the A company sales center terminal 600 (step H25).

After the A company sales center terminal 600 receives the point addition result (step H26), it transmits the point addition result together with information of a screen for allowing the customer 1 to confirm the point addition result to the user terminal 1000 (step H27). The user terminal 1000 receives the point addition result and the information of a screen for allowing the customer 1 to confirm the point addition result (step H28) and displays the fact that points involved in the purchase of the commodity through the input of the customer number 551 of the D company point card 550 are added correctly in the D company point management host computer 300 together with the point addition result on the display section 1002 so that the customer 1 may confirm the correct addition of points (step H29).

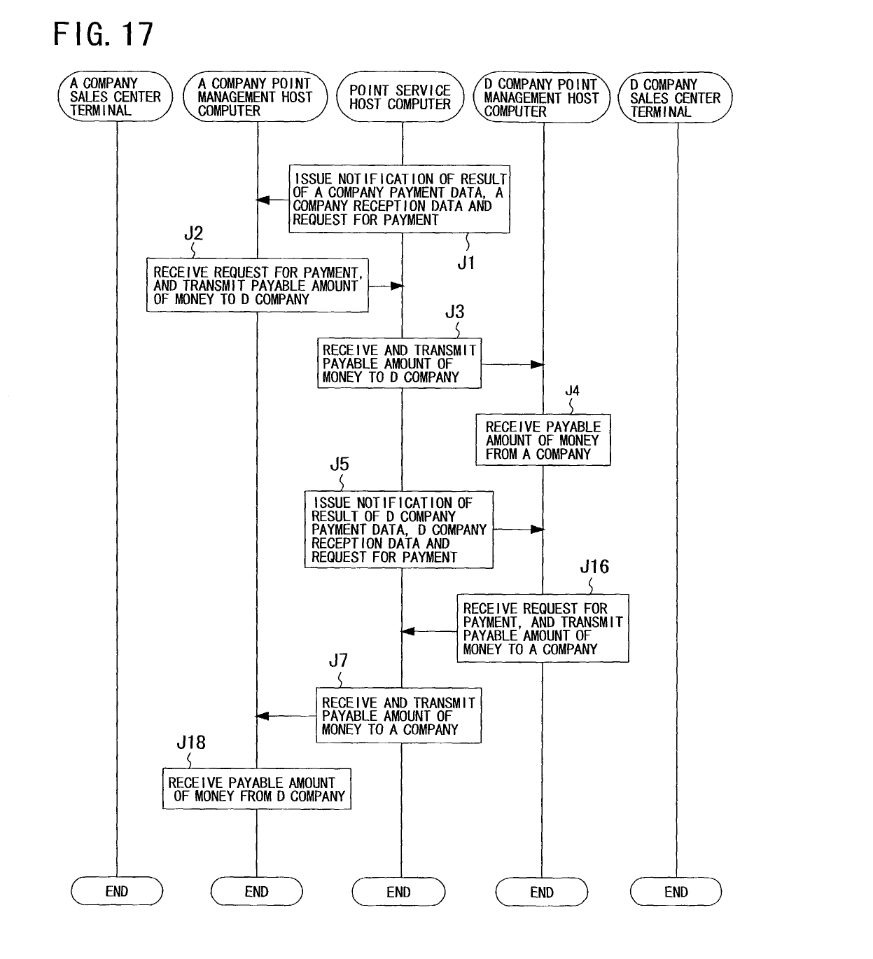

It is to be noted here that the point number added to the point number 340 with the point card of the D company through the point process described above is a point number to be serviced to the customer 1 by the A company at all due to the fact that the customer 1 purchases a commodity of the A company. Therefore, for the point number serviced to the customer 1 by the A company through the purchase of a commodity of the A company by the customer 1, a corresponding point number need be paid as a point number of the D company from the A company to the D company. Therefore, the point service host computer 100 adds the point addition result to the point card of the D company through the purchase of the customer 1 as a point service number to be paid from the A company to the D company to the A company payment data 114 and further stores, since the serviced point number is, as viewed from the D company, a point price to be received from the A company, the point number as a price to be received by the D company into the D company reception data 125 (step H30). The storage of each of the A company payment data 114 and the D company reception data 125 may be performed such that the data is converted into an amount of money corresponding to the point number and accumulated on the value of an amount of money accumulated already. It is to be noted that payment and reception of services (amounts of money) corresponding to point numbers between the A company and the D company (that is, settlement after transfer of point numbers is performed) are hereinafter described with reference to FIG. 17.

Subsequently, a point process when a customer purchases a commodity of the A company over a network using a point number accumulated in a point card of a company which provides a point service other than the A company in the point system of the second embodiment is described with reference to FIGS. 15 and 16. In other words, the point process is performed when a customer purchases a commodity from one of management enterprises other than an enterprise from which a customer number has been issued to the customer using points accumulated in the issuance source enterprise over a network. FIGS. 15 and 16 illustrate a flow of the point process when the customer 1 inputs the customer number 551 of a D company point card 550 thereof from a user terminal to purchase a commodity of the A company over a network.

It is assumed that, when the point addition process illustrated in FIGS. 15 and 16 is performed, the customer 1 possesses a D company point card 550 and the D company point management host computer 300 has data of the customer number 310, customer name 320, personal identification number 330 and point number 340 with regard to the customer 1 stored in the respective areas of the storage section 302 thereof.

Also it is assumed that the pertaining A company point conversion rate 112 is already stored as a conversion rate to be used for conversion of a point number of the D company into a point number of the A company when a commodity of the A company is purchased with a point number of the point card of the D company in a predetermined area of the storage section 102 based on an agreement concluded in advance between the A company and the D company.

Further, it is assumed that the A company point addition rate 113 is already stored as an addition rate to be used for conversion of a point number to be added by the D company into a point number to be added by the A company when a commodity of the D company is purchased with the point card of the A company in a predetermined area of the storage section 102 based on an agreement concluded in advance between the A company and the D company.

It is to be noted that different conversion tables coordinated with the commodity names 111 may be prepared such that the A company point conversion rates 112 and the A company point addition rates 113 have different values among different commodities or commodity groups to be purchased. In other words, the A company point conversion rate 112 and the A company point addition rate 113 may be stored for each commodity or commodity group to be purchased in a predetermined area of the storage section 102.

Also it is assumed that the pertaining D company point conversion rate 122 is already stored as a conversion rate to be used for conversion of a point number of the A company into a point number of the D company when a commodity of the D company is purchased with a point number of the point card of the A company in a predetermined area of the storage section 102 based on an agreement concluded in advance between the D company and the D company.

Further, it is assumed that the D company point addition rate 123 is already stored as an addition rate to be used for conversion of a point number to be added by the A company into a point number to be added by the D company when a commodity of the A company is purchased with the point card of the D company in a predetermined area of the storage section 102 based on an agreement concluded in advance between the D company and the D company.

It is to be noted that different conversion tables coordinated with the commodity names 121 may be prepared such that the D company point conversion rates 122 and the D company point addition rates 123 have different values among different commodities or commodity groups to be purchased. In other words, the D company point conversion rate 122 and the D company point addition rate 123 may be stored for each commodity or commodity group to be purchased in a predetermined area of the storage section 102.

It is to be noted that, in the following description, if the commodity purchased by the customer 1 is a commodity of the A company, then a point conversion rate A is used for the A company point conversion rate 112 and a point addition rate A is used for the A company point addition rate 113. In other words, values of the A company point conversion rate 112 and the A company point addition rate 113 coordinated with the commodity of the A commodity are used.

First, the customer 1 may operate the user terminal 1000 to access commodity information laid open by the A company sales center terminal 600 over the network 1100 (step I1). The A company sales center terminal 600 signals such commodity information to the user terminal 1000 over the network 1100 (step I2). The user terminal 1000 receives and displays the commodity information on the display section 1002 (step I3). The customer 1 may designate a commodity to be purchased from within the screen displayed on the display section 1002 (step I4) and input the customer number 551 of the D company point card 550 possessed thereby and a personal identification number (step I5). The user terminal 1000 transmits the inputted purchase commodity information, customer number 551 and personal identification number to the A company sales center terminal 600 (step I6).

The A company sales center terminal 600 receives the purchase commodity information, customer number 551 and personal identification number (step I7) and transmits the customer number 551 and the personal identification number of the customer 1 to the A company point management host computer 200 in order to inquire about the customer number 551 and the personal identification number (step I8).

The A company point management host computer 200 receives the purchased commodity information, customer number 551 and personal identification number (step I9). However, since received customer information is the customer number 551 of the D company and the personal identification number, the A company point management host computer 200 cannot collate the customer information. Therefore, the A company point management host computer 200 transmits the customer number 551 and the personal identification number to the point service host computer 100 (step I10). The point service host computer 100 receives the customer number 551 and the personal identification numbers and sends them to the D company point management host computer 300 in order to inquire about the customer number 551 of the D company and the personal identification number received (step I11).

The D company point management host computer 300 receives the customer number 551 and the personal identification number from the point service host computer 100 (step I12) and collates the received customer number 551 and personal identification number with the customer numbers 310 and the personal identification numbers 330, respectively, and then reads in the point number of the customer specified as a result of the collation from the point numbers 340. Then, the D company point management host computer 300 transmits the point number of the customer 1 in the D company thus read in to the point service host computer 100 (step I13).

The point service host computer 100 converts the point number of the D company received from the D company point management host computer 300 into a point number of the A company with the A company point conversion rate 112 and transmits the resulting point number of the A company to the A company point management host computer 200 (step I14). The A company point management host computer 200 transmits the received point number of the A company to the A company sales center terminal 600 (step I15).

The A company sales center terminal 600 receives the point number of the A company (step I16) and calculates an amount of money available for purchase in the A company based on a point number accumulated till then from the received point number of the A company with the internal conversion rate 630. Then, the A company sales center terminal 600 transmits the received point information of the card (point number accumulated till then and available for purchase), the amount of money available for purchase based on the point number and information regarding selection of a purchase method of the commodity to the user terminal 1000 in order to confirm whether the customer 1 uses, as a method of payment for the commodity to be purchased by the customer 1, a method wherein the point number accumulated till then is used for the payment or another method wherein the cash or a credit card is used for the payment for the commodity and points involved in the purchase of the commodity are added to the points accumulated till then (step 117).

The user terminal 1000 receives the point number accumulated till then and available for purchase, the amount of money available for purchase based on the point number and the information regarding selection of a purchase method of the commodity and displays them on the display section 1002 to urge the customer 1 to select a purchase method (step H18). FIGS. 15 and 16 illustrate the point process when the customer 1 pays for the purchased commodity using the point number accumulated in the point number 340 of the D company. It is to be noted that the point process when the method wherein points upon purchase of a commodity are added to the point number 340 of the D company is selected is described hereinabove with reference to FIGS. 13 and 14.

If the method wherein a point number is used to purchase the commodity is selected, then the user terminal 1000 transmits the information of the purchased commodity of the customer 1, the point subtraction information (that the method wherein points accumulated till then are used to purchase the commodity is selected) and the information of the method of payment of the price to the A company sales center terminal 600 (step I19). After the A company sales center terminal 600 receives the information of the purchased commodity and so forth, it calculates a point number to be subtracted with the internal conversion rate 630 from the price of the purchased commodity and transmits the calculated point number to be subtracted to the A company point management host computer 200 (step I20).

After the A company point management host computer 200 receives the point number to be subtracted, since the received point number to be subtracted is for the customer of the point card of the D company, the A company point management host computer 200 transmits the received point number to the point service host computer 100 (step I21). Since the received point number to be subtracted is a point number of the A company, the point service host computer 100 converts the point number into a point number of the D company with the A company point conversion rate 112 and transmits the resulting point number to the D company point management host computer 300 (step I22).

The D company point management host computer 300 subtracts the subtraction point number received from the point service host computer 100 from the point number in the point numbers 340 specified as a point number of the customer 1 as a result of the inquiry and transmits a result of the subtraction to the point service host computer 100 (step I23). After the point service host computer 100 receives the point subtraction result, it converts, in order to allow the customer 1 to confirm the point subtraction result, the received point subtraction result of the D company into a point subtraction result in the form of a point number of the A company with the A company point conversion rate 112 and transmits the resulting point subtraction result to the A company point management host computer 200 (step I24). The A company point management host computer 200 receives the point subtraction result in the form of a point number of the A company and transmits it to the A company sales center terminal 600 (step 125).

After the A company sales center terminal 600 receives the point subtraction result (step I26), it transmits the point subtraction result together with information of a screen for allowing the customer 1 to confirm the point subtraction result to the user terminal 1000 (step I27). The user terminal 1000 receives the point addition result and the information of a screen for allowing the customer 1 to confirm the point subtraction result (step I28) and displays the fact that points involved in the purchase of the commodity through the input of the customer number 551 of the D company point card 550 are subtracted correctly from the point number 340 of the D company point management host computer 300 after the commodity is purchased through the subtraction of the points from the point number accumulated in the point number 340 till then (that is, using the point number) together with the point subtraction result on the display section 1002 so that the customer 1 may be notified that the points are subtracted correctly (step I29).

It is to be noted here that the point number subtracted from the point number 340 with the point card of the D company through the point process described above is subtracted for the commodity of the A company purchased by the customer 1 from the point number accumulated as a point number of the customer 1 through the services of the D company at all. Therefore, for the price required for the purchase of the commodity of the A company, a corresponding amount of money need be paid as a point service result of the D company from the D company to the A company. Therefore, the point service host computer 100 adds the point subtraction result from the point card of the D company through the purchase of the commodity by the customer 1 as a point service number to be paid from the D company to the A company to the D company payment data 124 and further stores, since the subtracted point number is, as viewed from the A company, a point price to be received from the D company, the point number as a price to be received by the A company into the A company reception data 115 (step I30). The storage into each of the D company payment data 124 and the A company reception data 115 may be performed such that the data is converted into an amount of money corresponding to the point number and accumulated on the value of an amount of money accumulated already. It is to be noted that payment and reception of services (amounts of money) corresponding to point numbers between the A company and the D company (that is, settlement after transfer of point numbers is performed) are described below with reference to FIG. 17.

Now, a payment method and a reception method in settlement of a service price corresponding to a point number between the A company and the D company in the point process when a customer purchases a commodity of the A company indicating a point card of the D company described hereinabove with reference to FIGS. 13 to 16 are described with reference to FIG. 17. In other words, a flow of a point process for payment and reception of an accumulated price upon settlement after transfer of a point number between enterprises is described. FIG. 7 illustrates a flow of a point process for payment and reception of a service price corresponding to a point number between the A company and the D company when a customer purchases a commodity of the A company indicating a point card of the D company.

The point service host computer 100 stores, in the A company point conversion database 110 thereof, A company payment data 114 which represents an amount of money corresponding to points to be paid from the A company to the D company and A company reception data 115 which represents an amount of money to be received by the A company from the D company. The point service host computer 100 further stores, in the D company point conversion database 120 thereof, D company payment data 124 which represents an amount of money corresponding to points to be paid from the D company to the A company and D company reception data 125 which represents an amount of money to be received by the D company from the A company. It is to be noted that the time for the settlement of the prices is determined in advance in an agreement between the A company and the D company.

When the time for the settlement of the prices comes, the point service host computer 100 first notifies the A company point management host computer 200 of contents of the A company payment data 114 and the A company reception data 115 and issues a request for payment of a price corresponding to the A company payment data 114 (step J1). When the request for payment is received, the A company point management host computer 200 transmits the payable amount of money to the D company to the point service host computer 100 (step J2). The point service host computer 100 receives the payable amount of money and transmits it to the D company point management host computer 300 (step J3). The D company point management host computer 300 receives the payable amount of money and payment of the prices is performed thereby (step J4).

Similarly, when the time for payment of the prices comes, the point service host computer 100 first notifies the D company point management host computer 300 of contents of the D company payment data 124 and the D company reception data 125 and issues a request for payment of an amount of money corresponding to the D company payment data 124 (step J5). The D company point management host computer 300 receives the request for payment and transmits the payable amount of money to the A company to the point service host computer 100 (step J6). The point service host computer 100 receives the payable amount of money and transmits it to the A company point management host computer 200 (step J7). The A company point management host computer 200 receives the payable amount of money and payment of the prices is performed thereby (step J8).

It is to be noted that transmission-reception of an amount of money for the payment described above may be performed in accordance with a payment method such as payment by electronic money based on an agreement concluded in advance.

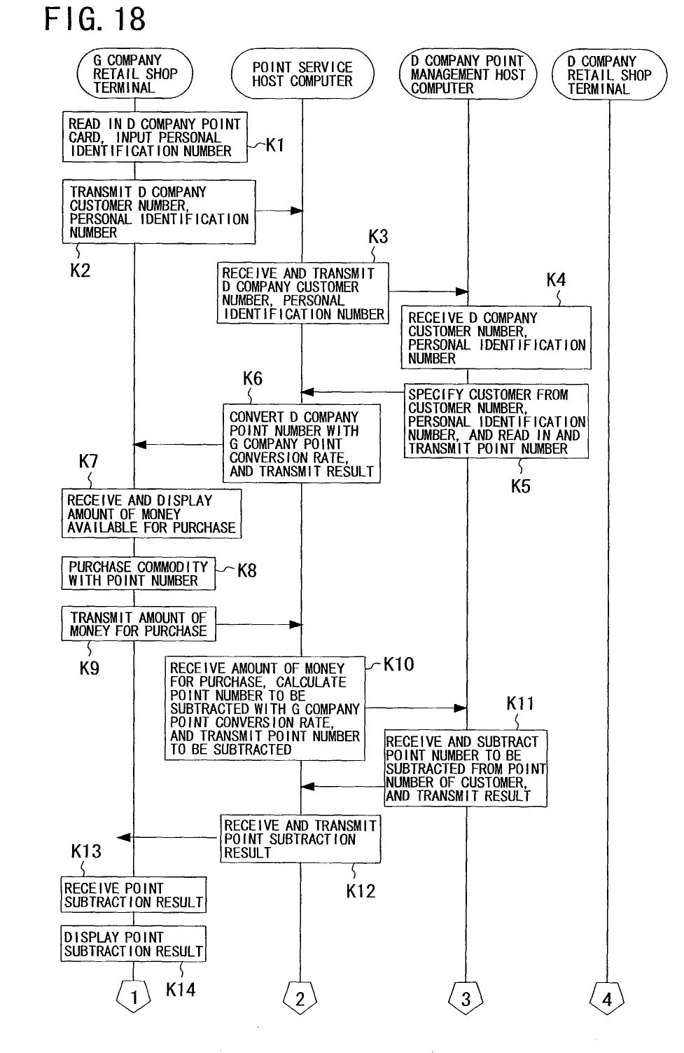

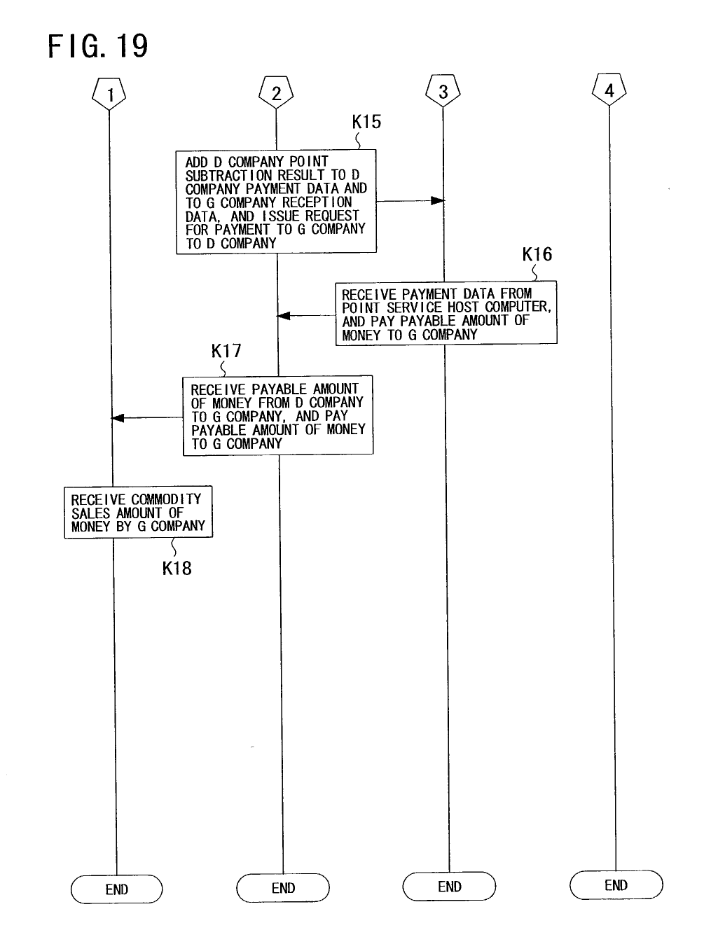

Now, a flow of a process when a customer purchases a commodity of the G company using a point number accumulated in the D company with a customer number issued by the D company from the G company retail shop terminal 900 of the G company which does not provide a point service in the point system of the second embodiment is described with reference to FIGS. 18 and 19. In particular, in the flow of the point process, a customer purchases a commodity of a selling source enterprise, which is one of member companies of the point system but is not a management enterprise, using a point number accumulated in the selling source enterprise (one of management enterprises) which has issued a customer number to the customer. FIGS. 18 and 19 illustrate a flow of a process when the customer 1 purchases a commodity of the G company using the pertaining point number 340 accumulated in the D company with the customer number 551 issued by the D company from the G company retail shop terminal 900 of the G company which does not provide a point service.

It is assumed that, in order to perform the point process illustrated in FIGS. 18 and 19, the customer 1 possesses a D company point card 550 and the D company point management host computer 300 has data of the customer number 310, customer name 320, personal identification number 330 and point number 340 with regard to the customer 1 stored in the respective areas of the storage section 302 thereof.

Also it is assumed that the G company conversion rate 135 is already stored as a conversion rate for conversion between a point number of the D company and a purchase price from the G company when a commodity of the G company is purchased with a point number of the D company in a predetermined area of the storage section 102 of the point service host computer 100. The G company conversion rate 135 stored has a value decided in advance based on an agreement concluded between the G company and the D company in advance in order to allow utilization of point cards with each other between the G company and the D company.

When the customer 1 tries to purchase a commodity of the G company in a retail shop of the G company, it may indicate the D company point card 550. The G company retail shop terminal 900 reads the customer number 551 and the customer name 552 from the indicated D company point card 550 by means of the reading section 901 and receives an input of a personal identification number of the customer 1 through the inputting section 902 (step K1). Then, in order to inquire about the customer 1 and confirm the point number possessed by the customer 1, the G company retail shop terminal 900 transmits the read customer number 551 and the inputted personal identification number to the point service host computer 100 (step K2). The point service host computer 100 receives the customer number 551 of the D company and the personal identification number and transmits them to the D company point management host computer 300 in order to inquire about them (step K3). The D company point management host computer 300 receives the customer number 551 and the personal identification number from the point service host computer 100 (step K4), and collates the received customer number 551 and personal identification number with the customer numbers 310 and the personal identification numbers 330, respectively, thereby to specify data of the customer 1 and reads in the point number of the specified customer 1 from the point numbers 340 and then transmits the point number to the point service host computer 100 (step K5).

The point service host computer 100 converts the point number received from the D company point management host computer 300 into an amount of money with the G company conversion rate 135 and transmits the resulting value of the amount of money to the G company retail shop terminal 900 (step K6). The G company retail shop terminal 900 receives the value of the amount of money of the customer 1, who possesses the D company point card 550, after the conversion, and displays on the display section 903, together with the value of the received amount of money, a screen for confirming whether the customer 1 uses, as a method of payment for the commodity to be purchased by the customer 1, a method wherein the point number accumulated till then is used for the payment or another method wherein the cash or a credit card is used for the payment for the commodity (step K7). In FIGS. 18 and 19, it is illustrated that the customer 1 selects the method wherein a point number accumulated in the point number 340 is used for the payment. It is to be noted that, if the customer 1 otherwise selects the method wherein the cash or the like is used for the payment of the commodity, then the payment is performed in a similar manner as in ordinary payment independent of the point process in the present embodiment.

If the method wherein a point number accumulated in the point number 340 is used for the payment is selected (step K8), then the G company retail shop terminal 900 transmits the amount of money (sales price) for the purchased commodity to the point service host computer 100 (step K9). The point service host computer 100 receives the value of the amount of money (sales price data) for the purchased commodity, and calculates a point number (a number of points to be subtracted) of the D company with the G company conversion rate 135 and transmits the resulting point number to the D company point management host computer 300 (step K10).

The D company point management host computer 300 subtracts the point subtraction number of the D company received from the point service host computer 100 from the point number specified as data of the customer 1 in the point numbers 340 as a result of the inquiry and transmits resulting data to the point service host computer 100 (step K11). The point service host computer 100 re-calculates, in order to allow the customer 1 to confirm the result of the point subtraction, the received point addition result with the G company conversion rate 135 and transmits the resulting point number to the G company retail shop terminal 900 (step K12). The G company retail shop terminal 900 receives the point subtraction result (step K13) and displays it as a result of the subtraction from the point number 340 of the D company point management host computer 300 when the customer 1 indicates the point card of the D company to purchase a commodity of the G company on the display section 903 so that the customer 1 may confirm that points are subtracted correctly from the point number 340 of the D company (step K14).

Here, according to the purchase of the commodity just described, a commodity of the G company is purchased with a point number accumulated in a point card of the D company. Since a service corresponding to the point number accumulated in the point card of the D company by the customer 1 is a service which is performed for an owner of a point card of the D company by the D company at all, a price corresponding to the point number used for the purchase of the commodity need be paid from the D company to the G company. Therefore, the point service host computer 100 adds the point subtraction result from the point number 340 with the point card of the D company arising from the purchase of a commodity of the G company by the customer 1 as a price to be paid from the D company to the G company to the D company payment data 124 and stores a result of the addition as a price to be received by the G company similarly into the G company reception data 136. Then, the point service host computer 100 issues to the D company, as a request for payment of the price to the G company, a request for payment of the price accumulated in the D company payment data 124 (step K15). The D company point management host computer 300 receives the request for payment of the price (data of the payable amount of money) from the point service host computer 100 and transmits the price for purchase corresponding to the points of the customer 1 to the point service host computer 100 (step K16). The point service host computer 100 receives the amount of money to be paid from the D company to the G company (the price for purchase corresponding to the points) and transmits it to the G company retail shop terminal 900 (step K17). The G company retail shop terminal 900 receives the price for purchase corresponding to the points of the customer 1, whereby the G company receives the sales price of the commodity to the customer 1 from the D company (step K18).

It is to be noted that, for such transmission and reception of an amount of money for the payment described above, a method of payment such as payment by electronic money may be taken in accordance with an agreement concluded in advance.

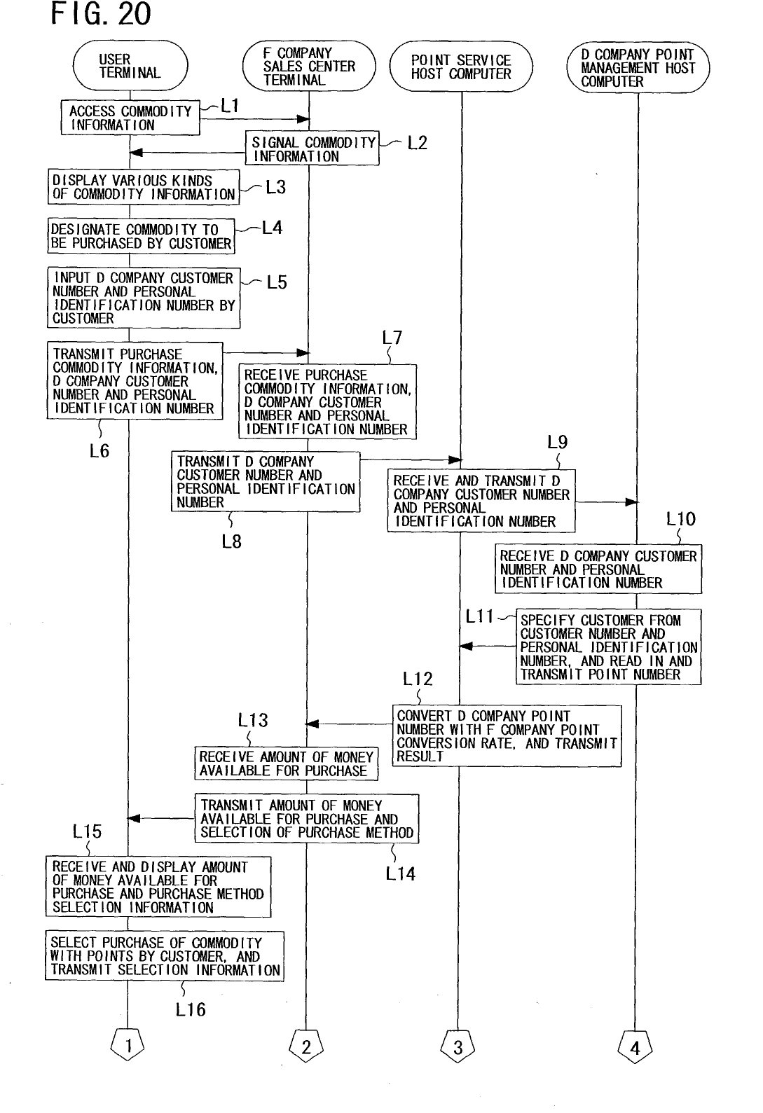

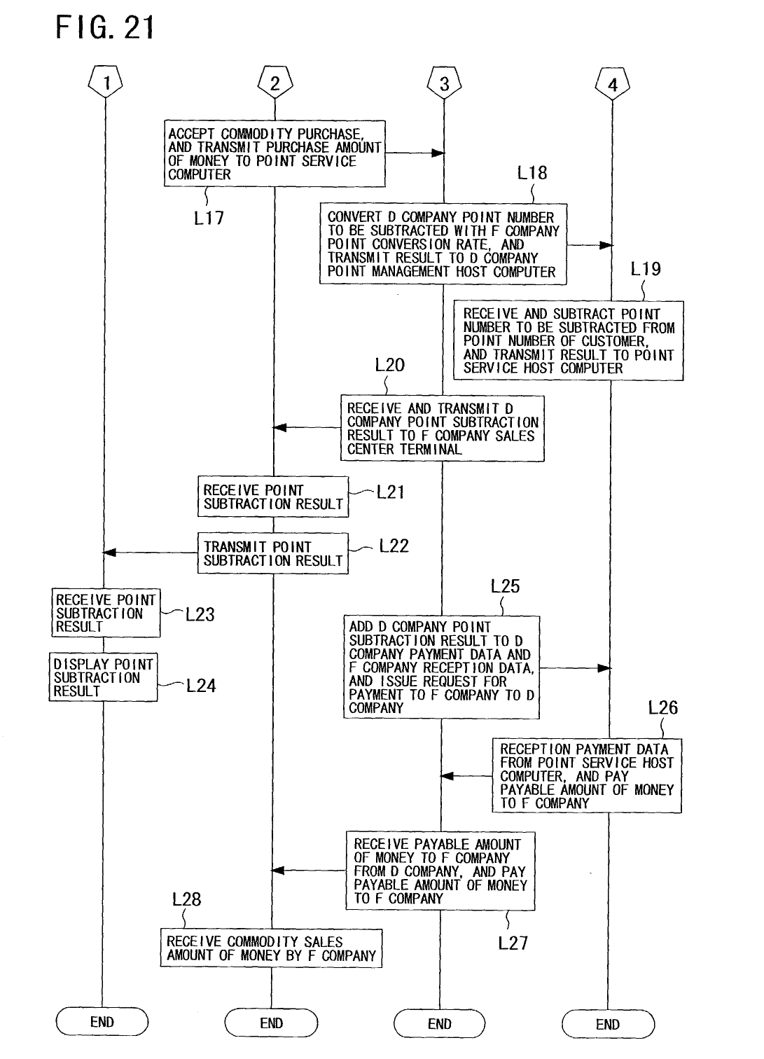

Now, a flow of a process when a customer purchases a commodity of the F company over the network 1100 using a point number accumulated in the D company with a customer number issued by the D company from the F company sales center terminal 800 of the F company which sells a commodity over the network 1100 but does not provide a point service in the point system of the second embodiment is described with reference to FIGS. 20 and 21. In particular, in the flow of the point process, a customer purchases a commodity of a selling source enterprise, which is one of member companies of the point system but is not a management enterprise, using a point number accumulated in the selling source enterprise (one of management enterprises) which has issued a customer number to the customer. FIGS. 20 and 21 illustrate a flow of a process when the customer 1 purchases a commodity of the F company over the network 1100 using the point number 340 accumulated in the D company with the customer number 551 issued by the D company from the F company sales center terminal 800 of the F company which does not provide a point service.

It is assumed that, when the point process illustrated in FIGS. 20 and 21 is performed, the customer 1 possesses a D company point card 550 and the D company point management host computer 300 has data of the customer number 310, customer name 320, personal identification number 330 and point number 340 with regard to the customer 1 stored in the respective areas of the storage section 302 thereof.

Also it is assumed that the F company conversion rate 131 is already stored as a conversion rate for conversion between a point number of the D company and a purchase price in the F company when a commodity of the F company is purchased with a point number of the D company in a predetermined area of the storage section 102 of the point service host computer 100. The F company conversion rate 131 stored has a value decided in advance based on an agreement concluded between the F company and the D company in order to allow utilization of point cards with each other between the F company and the D company.

First, the customer 1 may operate the user terminal 1000 to access commodity information of the F company laid open by the F company sales center terminal 800 over the network 1100 (step L1). The F company sales center terminal 800 transmits such commodity information to the user terminal 1000 over the network 1100 (step L2). The user terminal 1000 receives and displays the commodity information on the display section 1002 (step L3).

The customer 1 may designate a commodity to be purchased from within the screen displayed on the display section 1002 of the user terminal 1000 (step L4) and input the customer number 551 of the D company point card 550 possessed thereby and a personal identification number from the inputting section 1001 (step L5). The user terminal 1000 transmits information of the designated commodity to be purchased and the customer number 551 of the D company and the personal identification number inputted thereto to the F company sales center terminal 800 (step L6). The F company sales center terminal 800 receives the customer number 551 of the customer 1 and the personal identification number (step L7) and transmits the received customer number 551 and personal identification number to the point service host computer 100 in order to inquire about the customer number 551 and the personal identification number (step L8). The point service host computer 100 receives the customer number 551 of the D company and the personal identification number and transmits them to the D company point management host computer 300 in order to inquire about the customer number 551 and the personal identification number (step L9).

The D company point management host computer 300 receives the customer number 551 and the personal identification number from the point service host computer 100 (step L10) and collates the received customer number 551 and personal identification number with the customer numbers 310 and the personal identification numbers 330, respectively, and then reads in the point number specified as data of the customer 1 as a result of the collation from the point numbers 340. Then, the D company point management host computer 300 transmits the point number of the customer 1 to the point service host computer 100 (step L11). The point service host computer 100 converts the point number received from the D company point management host computer 300 into a payable price (purchase available amount of money) with the F company conversion rate 131 and transmits the resulting value of the price to the F company sales center terminal 800 (step L12).

The F company sales center terminal 800 receives the payable price (purchase available amount of money) based on the point number of the customer 1 (step L13) and transmits screen information for allowing selection of a purchase method of the commodity such as a method wherein the point number accumulated till then is used for the payment or another method wherein the cash or a credit card is used for the payment for the commodity as a method of payment for the commodity to be purchased by the customer 1 to the user terminal 1000 together with the value of the purchase available amount of money (step L14). The user terminal 1000 displays the purchase available amount of money and the screen for selection of a purchase method on the display section 1002 to urge the customer 1 to select a purchase method (step L15). In FIGS. 20 and 21, it is illustrated that the customer 1 selects the method wherein a point number accumulated in the point number 340 is used for the payment. It is to be noted that, if the customer 1 selects the method wherein the cash or the like is used for the payment of the commodity, then the payment is performed in a similar manner as in an ordinary case wherein a commodity is purchased over a network, and is independent of the point process in the present embodiment.

If the customer 1 selects the method wherein a point number accumulated in the point number 340 is used for the payment, then the user terminal 1000 transmits information of the selected payment method and the value of the amount of money of the purchased commodity to the F company sales center terminal 800 (step L16). The F company sales center terminal 800 accepts the purchase based on the payment in which a point number is used and transmits the value of the amount of money of the purchased commodity to the point service host computer 100 (step L17).

The point service host computer 100 re-calculates a point number of the D company (point subtraction number in the D company) with the F company conversion rate 131 from the received value of the amount of money of the purchased commodity and transmits the resulting pint number to the D company point management host computer 300 (step L18). The D company point management host computer 300 subtracts the point subtraction number in the D company received from the point service host computer 100 from the point number in the point numbers 340 specified as a point number of the customer 1 as a result of the inquiry and transmits a result of the subtraction to the point service host computer 100 (step L19). After the point service host computer 100 receives the point subtraction result, it transmits the point subtraction result to the F company sales center terminal 800 so that the customer 1 may confirm the point subtraction result (step L20).

After the F company sales center terminal 800 receives the point subtraction result (step L21), it transmits the point subtraction result together with information of a screen for allowing the customer 1 to confirm the point subtraction result to the user terminal 1000 (step L22). The user terminal 1000 receives the point subtraction result (step L23) and displays the fact that a point number corresponding to the price of a commodity purchased by the customer 1 using a point number through an input of the customer number 551 issued by the D company is subtracted from the point number 340 of the D company point management host computer 300 on the display section 1002 so that the customer 1 may confirm the correct subtraction from the point number 340 of the D company (step L24).

It is to be noted here that, in the present purchase of a commodity, a point number accumulated with the point card of the D company is used for the purchase of a commodity of the F company. Since the a service corresponding to the point number accumulated with the point card of the D company by the customer 1 is a service provided to an owner of a point card of the D company by the D company at all, a price corresponding to the point number used for the purchase of the commodity need be paid from the D company to the F company. Therefore, the point service host computer 100 adds the point subtraction result from the point number 340 based on the point card of the D company arising from the purchase of the commodity of the F company by the customer 1 as a price to be paid from the F company to the F company to the D company payment data 124 and further stores the point subtraction result as a price to be received by the F company similarly into the F company reception data 132. Then, the point service host computer 100 issues, as a request to the D company for payment of the price to the F company, a request for payment of the price accumulated in the D company payment data 124 to the D company point management host computer 300 (step L25). The D company point management host computer 300 receives the request for payment of the price (data of the payable amount of money) from the point service host computer 100 and transmits the price for purchase corresponding to the points of the customer 1 to the point service host computer 100 (step L26). The point service host computer 100 receives the price to be paid from the D company to the F company (the price for purchase corresponding to the points) and transmits it to the F company sales center terminal 800 (step L27). The F company sales center terminal 800 receives the price for purchase corresponding to the points of the customer 1, whereby the F company receives the sales price of the commodity to the customer 1 from the D company (step L28).

It is to be noted that, for such transmission and reception of an amount of money for the payment described above, a method of payment such as payment by electronic money may be taken in accordance with an agreement concluded in advance.

Although, in the embodiments described above, a customer number is issued together with a point card from an issuing source enterprise, they may be issued otherwise, for example, as a user ID and a password only if the customer number and the personal identification number are issued in a coordinated relationship.

Further, while, in the embodiments described hereinabove, the internal conversion rates possessed by the individual member enterprises are fixed values determined in the individual enterprises, they need not necessarily be fixed values, but, for example, different conversion rates may be set between addition and subtraction or among different days.

Further, in the embodiments described above, two cases are involved including a case wherein only two enterprises, that is, the A company and the D company, are management enterprises and only two member enterprises, that is, the A company and the D company, are involved and another case wherein two cases are involved including a case wherein only two enterprises, that is, the A company and the D company, are management enterprises and four member enterprises, that is, the A company and the D company as well as the F company and the G company, are involved. However, the number of enterprises is not limited to the numbers given above, but may be any number only if one or more management enterprises and a plurality of member enterprises are involved and data of conversion rates and so forth of the enterprises can be stored into the storage section 102 of the point service host computer 100. Where three or more management enterprises utilize the point system according to the present invention, the management enterprises individually include respective conversion means, receivable money amount storage means, payable money amount storage means and internal conversion means and are configured similarly as described hereinabove. Further, where three or more member enterprises which are not management enterprises utilize the point system according to the present invention, the member enterprises individually include respective conversion means and receivable money amount storage means and are configured similarly as described hereinabove.

While preferred embodiments of the present invention have been described using specific terms, such description is for illustrative purposes only, and it is to be understood that changes and variations may be made without departing from the spirit or scope of the following claims.

What is claimed is:

1. A point system, comprising:
one or more management enterprises for managing point services to purchase amounts of money of customers and a point management host computer provided in each of said management enterprises;
a plurality of member enterprises which are members of said point system including said management enterprises and a sales terminal provided in each of said member enterprises;
a point service host computer for integrating the point services; and
a network for interconnecting the point management host computers, the sales terminals and said point service host computer;
said point service host computer including point number conversion means for converting a point number of one of said management enterprises into a point number of another one of said management enterprises, receivable money amount storage means for storing values of a receivable amount of money upon settlement after a transfer of a point number is performed between different ones of said member enterprises, and payable money amount storage means for storing values of a payable amount of money upon the settlement after the transfer of a point number is performed between the different ones of said member enterprises;
each of said sales terminals including point/money amount conversion means for converting a commodity purchase amount of money in one of said management enterprises into a point number of the management enterprise and for converting a point number of one of said management enterprises into an amount of money available for purchase from the management enterprise;
whereby, when a customer inputs a customer number issued by one of said management enterprises and a personal identification number to the sales terminal of one of said member enterprises other than the issuing source enterprise from which the customer number has been issued, if the customer selects to store a point number based on the purchase amount of money for the commodity into the issuing source enterprise, the purchase amount of money for the commodity is converted into a point number of a selling source one of the member enterprises from which the commodity is to be purchased by said point/money amount conversion means and the point number obtained by the conversion by said point/money amount conversion means is converted into a point number of the issuing source enterprise by said point number conversion means, and the point number obtained by said point number conversion means is added to the point number stored in a coordinated relationship with the customer number of the customer and then the value of the purchase amount of money for the commodity is stored into said payable money amount storage means for the selling source enterprise and said receivable money amount storage means for the issuing source enterprise, but if the customer selects to use the point number stored in the issuing source enterprise to purchase the commodity, the purchase amount of money for the commodity is converted into a point number of the selling source enterprise by said point/money amount conversion means and the point number obtained by the conversion by said point/money amount conversion means is converted into a point number of the issuing source enterprise by said point conversion means, and the point number obtained by the conversion by said point conversion means is subtracted from the point number stored in a coordinated relationship with the customer number of the customer in the issuing source enterprise and then the value of the purchase amount of money for the commodity is stored into said receivable money amount storage means for the selling source enterprise and said payable money amount storage means for the issuing source enterprise.

2. A point system as claimed in claim 1, wherein said point service host computer further includes second point/money amount conversion means for converting a purchase amount of money in one of said member enterprises other than said management enterprises into a point number of one of said management enterprises and for converting a point number of one of said management enterprises into an amount of money available for purchase from one of said member enterprises other than said management enterprises, whereby, when a customer inputs a customer number issued by one of said management enterprises and a personal identification number to the sales terminal of one of said member enterprises other than said management enterprises to purchase a commodity, the purchase amount of money for the commodity is converted into a point number of the issuing source enterprise of the customer number of the customer by said second point/money amount conversion means and the point number obtained by the conversion by said second point/money amount conversion means is subtracted from the point number stored in a coordinated relationship with the customer number of the customer in the issuing source enterprise, and then the value of the purchase amount of money for the commodity is stored into said receivable money amount storage means for the selling source enterprise and said payable money amount storage means for the issuing source enterprise.

3. A point system as claimed in claim 1, wherein each of the sales terminals accepts an input of the customer number and the personal identification number over said network from a terminal apparatus of the customer connected to said network.

4. A point system as claimed in claim 1, wherein the issuing source enterprise issues the customer number of the customer and the personal identification number with a point card, and each of the sales terminals is installed in a retail shop and receives an input of the customer number and the personal identification number through the point card.

5. A sales method which uses a point system including one or more management enterprises for managing point services to purchase amounts of money of customers and a point management host computer provided in each of said management enterprises, a plurality of member enterprises which are members of said point system including said management enterprises and a sales terminal provided in each of said member enterprises, a point service host computer for integrating the point services, and a network for interconnecting the point management host computers, the sales terminals and said point service host computer, comprising:
an acceptance step executed by one of the sales terminals of accepting a customer number and a personal identification number from a customer;
a transmission step executed by the sales terminal of transmitting the customer number and the personal identification number to the point management host computer of an issuing source one of said management enterprises from which the customer number has been issued;
a reading-in step executed by the point management host computer of collating the customer number and the personal identification number received from the sales terminal with data stored in a storage section of the point management host computer to read in a point number coordinated with the customer number;
a point conversion step executed by said point service host computer of converting the point number of the issuing source enterprise read in at the reading-in step into a point number of a selling source one of said member enterprises from which the commodity is to be purchased;
a money amount conversion step of converting the point number obtained by the conversion at the point conversion step into an amount of money available for purchase with the sales terminal;
a display step executed by the sales terminal of displaying the amount of money available for purchase obtained by the conversion at the money amount conversion step and a screen for allowing the customer to select whether or not the amount of money available for purchase isused to purchase the commodity with the sales terminal;
an addition step of adding, when the customer selects to purchase the commodity without using the amount of money available for purchase on the screen for selection, a point number corresponding to the amount of money available for purchase of the commodity to the point number coordinated with the customer number and cumulatively storing the value of the purchase amount of money for the commodity into said payable money amount storage means for the selling source enterprise and said receivable money amount storage means for the issuing source enterprise;
a subtraction step of subtracting, when the customer selects to use the amount of money available for purchase to purchase the commodity on the screen for selection, a point number corresponding to the purchase amount of money for the commodity from the point number coordinated with the customer number and cumulatively storing the value of the purchase amount of money for the commodity into said receivable money amount storage means for the selling source enterprise and said payable money amount storage means for the issuing source enterprise; and
a payment step of paying, at a time determined in advance after the commodity is sold to the customer through the addition step or the subtraction step, the amount of money stored in said payable money amount storage means for the issuing source enterprise from the issuing source enterprise to the selling source enterprise and paying the amount of money stored in said payable money amount storage means for the selling source enterprise from the selling source enterprise to the issuing source enterprise.

6. A sales method as claimed in claim 5, wherein, at the acceptance step, the customer number and the personal identification number are accepted over said network from a terminal apparatus of the customer connected to said network.

7. A sales method as claimed in claim 5, wherein, at the acceptance step, a point card issued by the issuing source enterprise is read in by the sales terminal located in a retail shop to accept the customer number and the personal identification number.

8. A sales method which uses a point system including one or more management enterprises for managing point services to purchase amounts of money of customers and a point management host computer provided in each of said management enterprises, a plurality of member enterprises which are members of said point system including said management enterprises and a sales terminal provided in each of said member enterprises, a point service host computer for integrating the point services, and a network for interconnecting the point management host computers, the sales terminals and said point service host computer, comprising:
an acceptance step executed by one of the sales terminals of accepting a customer number and a personal identification number from a customer;
a transmission step executed by the sales terminal of transmitting the customer number and the personal identification number to the point management host computer of an issuing source one of said management enterprises from which the customer number has been issued;
a reading-in step executed by the point management host computer of collating the customer number and the personal identification number received from the sales terminal with data stored in a storage section of the point management host computer to read in a point number coordinated with the customer number;
a conversion step executed by said point service host computer of converting the point number of the issuing source enterprise read in at the reading-in step into an amount of money available for purchase with the sales terminal;
a display step executed by the sales terminal of displaying the amount of money available for purchase and a screen for allowing the customer to select whether or not the amount of money available for purchase is used to purchase the commodity with the sales terminal;
a sales step of selling the commodity with the cash when the customer selects to purchase the commodity without using the amount of money available for purchase on the screen for selection;
a subtraction step of subtracting, when the customer selects to use the amount of money available for purchase to purchase the commodity on the screen for selection, a point number corresponding to the purchase amount of money for the commodity from the point number coordinated with the customer number and cumulatively storing the value of the purchase amount of money for the commodity into said receivable money amount storage means for the selling source enterprise and said payable money amount storage means for the issuing source enterprise; and
a payment step of paying, after the commodity is sold to the customer through the subtraction step, the amount of money stored in said payable money amount storage means for the issuing source enterprise to the selling source enterprise.

9. A sales method as claimed in claim 8, wherein, at the acceptance step, the customer number and the personal identification number are accepted over said network from a terminal apparatus of the customer connected to said network.

10. A sales method as claimed in claim 8, wherein, at the acceptance step, a point card issued by the issuing source enterprise is read in by the sales terminal located in a retail shop to accept the customer number and the personal identification number.

11. A program for causing a point system, which includes one or more management enterprises for managing point services to purchase amounts of money of customers and a point management host computer provided in each of said management enterprises, a plurality of member enterprises which are members of said point system including said management enterprises and a sales terminal provided in each of said member enterprises, a point service host computer for integrating the point services, and a network for interconnecting the point management host computers, the sales terminals and said point service host computer, to execute:
an acceptance process by one of the sales terminals of accepting a customer number and a personal identification number from a customer;
a transmission process by the sales terminal of transmitting the customer number and the personal identification number to the point management host computer of an issuing source one of said management enterprises from which the customer number has been issued;
a reading-in process by the point management host computer of the issuing source enterprise of collating the customer number and the personal identification number received from the sales terminal with data stored in a storage section of the point management host computer to read in a point number coordinated with the customer number;
a point conversion process by said point service host computer of converting the point number of the issuing source enterprise read in through the reading-in process into a point number of a selling source one of said member enterprises from which the commodity is to be purchased;
a money amount conversion process by the sales terminal of converting the point number read in into an amount of money available for purchase with the sales terminal;
a display process by the sales terminal of displaying the amount of money available for purchase obtained through the money amount conversion process and a screen for allowing the customer to select whether or not the amount of money available for purchase is used to purchase the commodity with the sales terminal;
an addition process by the point management host computer of the issuing source enterprise of adding, when the customer selects to purchase the commodity without using the amount of money available for purchase on the screen for selection, a point number corresponding to the amount of money available for purchase of the commodity to the point number coordinated with the customer number;
a process by said point service host computer of cumulatively storing the value of the purchase amount of money for the commodity into payable money amount storage means for the selling source enterprise and receivable money amount storage means for the issuing source enterprise;
a subtraction process by said point management host computer of the issuing source enterprise of subtracting, when the customer selects to use the amount of money available for purchase to purchase the commodity on the screen for selection, a point number corresponding to the purchase amount of money for the commodity from the point number coordinated with the customer number;
a process by said point service host computer of cumulatively storing the value of the purchase amount of money for the commodity into receivable money amount storage means for the selling source enterprise and payable money amount storage means for the issuing source enterprise;
a process by the point management host computer of the issuing source enterprise of paying, at a time determined in advance after the commodity is sold to the customer through the addition process or the subtraction process, the amount of money stored in said payable money amount storage means for the issuing source enterprise to the selling source enterprise; and
a process by the point management host computer of the selling source enterprise of paying the amount of money stored in said payable money amount storage means for the selling source enterprise to the issuing source enterprise.

12. A program as claimed in claim 11, wherein, in the acceptance process, the customer number and the personal identification number are accepted over said network from a terminal apparatus of the customer connected to said network.

13. A program as claimed in claim 11, wherein, in the acceptance process, a point card issued by the issuing source enterprise is read in by the sales terminal located in a retail shop to accept the customer number and the personal identification number.

14. A program for causing a point system, which includes one or more management enterprises for managing point services to purchase amounts of money of customers and a point management host computer provided in each of said management enterprises, a plurality of member enterprises which are members of said point system including said management enterprises and a sales terminal provided in each of said member enterprises, a point service host computer for integrating the point services, and a network for interconnecting the point management host computers, the sales terminals and said point service host computer, to execute:
an acceptance process by one of the sales terminals of accepting a customer number and a personal identification number from a customer;
a transmission process by the sales terminal of transmitting the customer number and the personal identification number to the point management host computer of an issuing source one of said management enterprises from which the customer number has been issued;
a reading-in process by the point management host computer of the issuing source enterprise of collating the customer number and the personal identification number received from the sales terminal with data stored in a storage section of the point management host computer to read in a point number coordinated with the customer number;
a conversion process by said point service host computer of converting the point number of the issuing source enterprise read in at the reading-in process into an amount of money available for purchase with the sales terminal;
a display process by said point service host computer of displaying the amount of money available for purchase and a screen for allowing the customer to select whether or not the amount of money available for purchase is used to purchase the commodity with the sales terminal;
a subtraction process by the point management host computer of the issuing source enterprise of subtracting, when the customer selects to use the amount of money available for purchase to purchase the commodity on the screen for selection, a point number corresponding to the purchase amount of money for the commodity from the point number coordinated with the customer number;
a storage process by said point service host computer of cumulatively storing the value of the purchase amount of money for the commodity into receivable money amount storage means for the selling source enterprise and payable money amount storage means for the issuing source enterprise; and
a process by the point management host computer of the issuing source enterprise of paying, after the storage process is completed, the amount of money stored in said payable money amount storage means for the issuing source enterprise to the selling source enterprise.

15. A program as claimed in claim 14, wherein, in the acceptance process, the customer number and the personal identification number are accepted over said network from a terminal apparatus of the customer connected to said network.

16. A program as claimed in claim 14, wherein, in the acceptance process, a point card issued by the issuing source enterprise is read in by the sales terminal located in a retail shop to accept the customer number and the personal identification number.
